(19) United States
(12) Patent Application Publication
(10) Pub. No.: US 2026/0084277 A1
(43) Pub. Date: Mar. 26, 2026

(54) Impacting Device with Long Adjustable Stroke Length, Enhanced Safety Features, and a Reciprocating Barrel Cam Mechanism

(71) Applicants: Darcy Daugela, Edmonton (CA); Brendan Gallagher, Edmonton (CA); Matt Carr, Edmonton (CA)

(72) Inventors: Darcy Daugela, Edmonton (CA); Brendan Gallagher, Edmonton (CA); Matt Carr, Edmonton (CA)

(21) Appl. No.: 19/036,473

(22) Filed: Jan. 24, 2025

Related U.S. Application Data
(60) Provisional application No. 63/569,213, filed on Mar. 24, 2024.
(60) Provisional application No. 63/625,012, filed on Jan. 25, 2024.

(51) Int. Cl. B25D 11/00; B25D 17/02; B25D 17/11

(52) U.S. Cl. CPC B25D 11/005; B25D 17/02; B25D 17/11; B25D 2250/021; B25D 2250/045; B25D 2250/375; B25D 2250/381

(57) ABSTRACT

The present disclosure elaborates on a prior disclosure related to making a powered impact device. That device could optionally attach to a power tool, have adjustable energy per impact, or have an elongated body so the impact energy is generated close to the impact target. The present disclosure relates to a design of the impacting device using a barrel cam to increase the stroke length and make the stroke length adjustable. Further, the present disclosure also relates to several safety features of the impacting device. These safety features include the ability to discharge any stored energy when not in use, the ability not to be damaged when the drive shaft is driven in the wrong direction, and a push to activate feature that reduces the chances of a potentially destructive air strike. Further, the present disclosure elaborates on alternative tool heads.

### PRIORITY CLAIM

This non-provisional patent application claims the benefit of U.S. Provisional Application No. 63/625,012 filed on January 25, 2024 and U.S. Provisional Application No. 63/569,213 filed on March 24, 2024, the entirety of both are incorporated herein by reference.

### FIELD

The present disclosure relates to making a powered impact device with adjustable impact energy per strike. The device can be configured to deliver an impact energy per strike sufficient for the application without unnecessarily causing unwanted damage. More particularly, the present disclosure is related to a tool that can act as a high-impact source and could be used in applications like an ice chipper, a powered scraper, a demolition tool, a powered shovel, a powered hammer, a jackhammer, a post hole digger, a high-powered impacting drill, a cutting tool, chisel, scraper, or other similar devices where the operator can benefit from the operator being able to adjust the impact energy.

The present disclosure elaborates on a prior disclosure related to making a powered impact device. That device could optionally attach to a power tool, have adjustable energy per impact, or have an elongated body so the impact energy is generated close to the impact target.

The present disclosure relates to a design of the impacting device using a barrel cam to increase the stroke length and make the stroke length adjustable.

Further, the present disclosure also relates to several safety features of the impacting device. These safety features include the ability to discharge any stored energy when not in use, the ability not to be damaged when the drive shaft is driven in the wrong direction, and a “push to activate” feature that reduces the chances of a potentially destructive “air strike.”

Further, the present disclosure elaborates on alternative tool heads.

### BACKGROUND

This disclosure elaborates on a prior disclosure titled “Impacting Device with Adjustable Impact Energy, Elongated Body, or Configured as an Attachment to a Drill or Lawn Trimmer” that was filed Jan 25, 2024, at the USPTO application number 63/625,012. This disclosure hereby includes the entire prior disclosure by reference. That prior disclosure includes several definitions used in this document and is therefore entirely incorporated by reference and to which the reader is directed for further information.

### Long Stroke Length Benefits

The vibration caused by an impacting device can negatively impact the device operators and cause physical harm or exhaustion from extended use. The European Union has regulated limits on how long an operator can operate an impacting tool based on the acceleration and vibration generated while using the tool. A tool that generates a lower vibration force is therefore generally desirable.

The vibration that acts on an operator is typically not the impact energy of the striker on the anvil but instead is the reaction force caused during the downstroke of the striker. A higher reaction force can cause a higher vibration experienced by the device operator. The impact energy delivered to the target, equals the product of the force applied to the striker, and the distance this force is applied. (Energy=force*distance).

Current handheld impacting tools typically use a small striker stroke length, typically less than about 25mm, because of the geometry limitations imposed by the popular cam designs. To achieve a high impact energy (e.g. over 20ft lbs), a high force (e.g. 100-600lbf), accelerates a striker over a short stroke length (e.g. 0.25 to 1 inches). The operator then experiences this high force as device vibration. This high vibration makes the device more difficult to hold, less precise in its strikes, and prolonged use may cause injuries. Some regions regulate the duration an impacting tool can be used based on the vibration and acceleration to improve operator safety.

Alternatively, a handheld impacting tool with a long stroke length, can generate a much lower reaction force (vibration), and still generate the same impact energy per strike. Alternatively, a much higher impact can be generated by a tool with a long stroke length and keep the vibration the same.

The reduced reaction force resulting from a longer stroke length can also enhance the controllability of the tool, thereby enabling the operator to position impacts on the target with greater precision.

The impact tool’s “controllability” can be described by a ratio of two opposing forces during the downstroke. Specifically, a reaction force generated by the impact mechanism tends to lift the tool head off the target, while a downward force counters that lift. The downward force can be the sum of both the tool’s own weight and the push-down force exerted by the operator. A “controllability ratio” (CR) may thus be defined as the quotient of this total downward force divided by the maximum reaction force. When the CR exceeds 1, the downward force is sufficient to keep the tool head firmly on the target, enabling more precise and controlled impacts. Conversely, if the CR is below 1, the reaction force dominates, causing the tool head to lift or recoil from the target and reducing precision.

To improve controllability, reducing the reaction force is desirable, which may be achieved by increasing the stroke length of the impact mechanism. Furthermore, a tool design that allows the operator to safely and comfortably apply or augment the push-down force can further increase the CR, thereby enhancing stability and precision during operation.

In addition, the increased stroke length can provide higher impact energy per strike, allowing the operator to complete the task more efficiently and quickly by striking more precisely and with greater energy.

Even if the impact rate is reduced to facilitate the longer stroke length, many common tasks can be performed quicker with fewer precise high-impact strikes than with a greater number of low-energy, imprecise strikes.

What is, therefore, needed is an impacting tool with a long stroke length. Methods for increasing the stroke length through the use of a barrel cam, or pulley system are given in the disclosure herein.

### Adjustable Impact Energy Per Strike Benefits

What is generally needed is an impact tool equipped with adjustable impact energy per strike. Such adjustability enables an operator to tailor the impact force to the requirements of the task. For example, when removing ice from a sidewalk, the selected energy level may be high enough to break the ice but not so high as to damage the underlying sidewalk. Likewise, when removing flooring material, the operator can choose an impact level sufficient to detach the flooring efficiently without harming the subfloor. By preventing over-penetration and excessive impact energy per strike, this feature not only preserves the underlying material but also permits the use of sufficiently high impact energy per strike to complete the work efficiently.

Adjusting the impact energy per strike also offers significant operational benefits by allowing the user to balance speed, efficiency, and precision. Higher impact energy can expedite tasks, reducing the time required for completion and increasing overall efficiency, particularly in heavy-duty applications. However, excessive energy can risk causing damage to delicate components, materials, or surroundings. Conversely, lower impact energy minimizes the potential for damage and is better suited for precision tasks, though it may result in longer completion times and reduced efficiency. By providing adjustable impact energy, the tool ensures optimal performance across a wide range of applications, enabling efficient operation while mitigating the risk of unintended damage.

### Barrel Cam Spring Mechanism

In one arrangement, a barrel cam and follower can have a long cylinder that enables a long stroke length. One means of having an adjustable stroke length is to remove the follower from the barrel cam at the top of the stroke and re-insert the follower at the bottom of the stroke. One challenge with this method is that it is important that the follower does not contact the barrel cam during the downstroke until the impact energy in the striker is released into the anvil. If the follower contacts the barrel cam track while the striker has high kinetic energy, it can cause a failure of the mechanism. What is desired is a means to hold the follower away from the barrel cam during the downstroke until the striker energy is released. This disclosure describes a configuration that holds the follower away from the barrel cam during the downstroke using the acceleration forces on the follower and follower linkage.

### Anvil Impact Isolation

The prior disclosure in FIG. 7 and FIG. 8 disclosed an anvil design wherein the anvil is directly coupled to the housing. This anvil design has certain advantages; however, a portion of the impact energy is delivered into the housing. This creates stress on the housing and also reduces the impact energy going into the target.

The present disclosure describes an apparatus and method of isolating the impact energy from the housing using an alternative anvil design. This alternative anvil design reduces the stress induced on the housing and increases the energy going into the target. The benefits of such an isolation anvil arrangement become more important as the amount of impact energy per strike increases.

### Anvil Noise Reduction

In embodiments, the prior disclosure disclosed an anvil arrangement wherein the striker hit the anvil directly. This design has certain advantages; however, it results in a generally large noise generated on each strike. This noise may restrict where and when the tool can be used. The present disclosure describes a way to reduce this generated noise. In particular, the harsh high frequency sound generated from a metal on metal interaction can be reduced by adding a noise absorbing pad between the striker and the anvil.

### Air Strike Reduction, Push to Activate

An air strike may occur when the impact energy generated does not go into a target, and therefore the impact energy has to be absorbed by the device. This can happen when the tool is held in the air at the time of the impact, instead of being pressed against the target. An air strike may present certain disadvantages. Such an air strike may waste energy and can potentially cause impact stresses and damage to the tool housing and body. In addition, this impact energy may travel up to the tool operator. This is an issue that can often occur with impact devices.

Therefore, reducing the chances of an airstrike can create certain benefits. The present disclosure describes a design arrangement wherein the impact tool needs to be pressed against a target before the impact tool begins to store energy for the impact.

### Powering Device Reverse Protection

Powering devices (e.g., drills) often allow a powering device operator to reverse the direction the device rotates. An impacting device that uses industry standard cam designs for impact tools can often jam and can potentially cause damage if the drill is rotated in the direction opposite to what impact device is designed for. A cam design is needed for an impacting tool that will reduce the potential for damage if the drill is operated in the opposite direction. This present disclosure describes such a desired cam design.

### Stored Energy Discharge

Stored energy in a spring can represent a potential safety hazard if this stored energy is released in an unexpected way or at an unexpected time. For example, if an operator stores the impacting tool while it has energy stored in the spring, and then at an unexpected time later, the energy in the spring is released, and the potentially dangerous impact energy is released through a sharp tool head. What is desired, therefore, is a means to ensure that stored energy in the spring is released when the tool stops operating. This disclosure describes a method to implement such a feature.

### Adjustable Power Tool Attachment

The prior disclosure described how the impact device can be designed to attach to a powering device. A powering device is a device that can turn a drive shaft and often is connected to a motor and a power source. Examples of powering devices are drills or lawn trimmers but can be any general similar device that can turn a drive shaft of the impact device. By designing the impact device as an attachment, it is possible to lower the cost of the device since the impact device does not require an integral motor or power source.

Additionally, if the power source comprises a battery, the operator of the impact device can use the batteries from an existing power tool and does not need to purchase batteries. These batteries can then integrate with any other tools which can be an important feature for many operators.

### Adjustable Impact Tool Attachment Angle

When an impacting device is attached to a powering device, it is desirable to give the operator a choice of what orientation to mount the power device relative to the tool head. For example, if the impacting device comprises chipping ice by orienting the impacting device perpendicular to the ground, then it is often convenient to have the impacting device handle perpendicular to the tool head. This allows the operator to stand up and push the tool forward or down easily.

An alternative example is if the impacting tool is used to remove roofing tiles, then the operator may want to orient the tool as close to parallel to the roof as possible. In this alternative arrangement, it may be preferable for the operator to orient the powering device, so that the handle is parallel to the tool head (instead of perpendicular to the tool head). This allows the operator to lower the impacting device angle as close to the roof angle as possible. It is therefore desirable for the tool operator to be able to rotate the angle of the powering device relative to the tool head. This disclosure describes apparatus and methods for achieving such an alternative impact tool arrangement.

### Adjustable Impact Tool Length

It is desirable to make the length of the impacting device adjustable by the operator. This is because operators can be of different heights and sizes and will find different impacting device lengths more ergonomic and comfortable. Additionally, different jobs performed may require different tool lengths. For example, removing floor tiles in a small bathroom may be best accomplished by making the tool length as short as possible so that the impact device will fit in tight spaces. Another contrary example is that scraping plaster off a wall or ceiling may be best suited to making the tool length as long as possible to reach the plaster at a further distance. Therefore, it is desirable to adjust the impact device tool length. The present disclosure describes apparatus and methods for achieving such an alternative impact tool arrangement.

### SUMMARY

This disclosure elaborates on a prior disclosure titled “Impacting Device with Adjustable Impact Energy, Elongated Body, or Configured as an Attachment to a Drill or Lawn Trimmer” that was filed Jan 25, 2024 at the USPTO application number 63/625,012.

An impacting device described in the prior disclosure wherein :

the stroke length of the device exceeds the characteristic dimension of the housing, thereby creating a longer stroke length, which reduces the vibrational forces on the operator and increases the precision and impact energy per strike.

the impact energy per strike is adjustable by the operator.

A barrel cam is used to raise the striker.

the impacting device has a long reach design

the impact force on the anvil is mechanically isolated from the tool body

a noise dampener reduces the noise from the impact force

the chances of an air strike are reduced by requiring the device operator to push in the anvil to activate the tool

the impact device is not damaged if the drive shaft is turned in the wrong direction.

When the impact device is deactivated, energy stored in the device is automatically discharged to a safe condition.

the length of the tool is adjustable by the device operator

the angle of an attached powering device relative to the Tool Head can be configured by the device operator.

### BRIEF DESCRIPTION OF THE DRAWINGS

The novel features believed to be characteristic of the illustrative embodiments are set forth in the appended claims. The illustrative embodiments, however, as well as a preferred mode of use, further objectives, and descriptions thereof, will best be understood by reference to the following detailed description of one or more illustrative embodiments of the present disclosure when read in conjunction with the accompanying drawings, wherein:

FIG. 1 illustrates a view of an impacting tool with an adjustable impact energy per stroke;

FIG. 2 illustrates a view of multiple components inside an impacting tool with an adjustable impact energy per stroke, such as the impacting tool illustrated in FIG. 1;

FIG. 3 illustrates a view of an impacting tool that is an attachment to an existing power tool, such as a drill, lawn trimmer, or other powering device;

FIG. 4 a view of multiple components inside an impacting tool attachment, such as illustrated in FIG. 3;

FIG. 5 illustrates a view of an impacting tool that is an attachment to an existing power tool, such as a lawn trimmer;

FIG. 6 a view of multiple components inside an impacting tool attachment, such as illustrated in FIG. 5;

FIG. 7 a cut through view of the internals of the striker cam assembly 360;

FIG. 8 illustrates a cross-section view of an example striker cam assembly;

FIG. 9 illustrates the tool body assembly and the major components between the Powering Device Mount and the tool holder;

FIGS. 10a (bottom of stroke) and 10b (top of stroke) illustrates the barrel cam, striker, follower assembly, and anvil assembly. This figure is used to describe how these components interact to affect the striker cycling sequence;

FIG. 11 illustrates the barrel cam bottom detail. This figure is used to describe the reverse protection feature, and the push to activate feature;

FIG. 12 illustrates the isolation anvil and tool holder. This figure is used to describe how in normal operation, the impact energy of the striker is transmitted into the target, without going through the tool housing;

FIG. 13A and 13B describes how the powering device is mounted to drive the tool drive shaft. It is used to describe the features of being able to rotate the powering device relative to the Tool Head, and how the tool length can be adjusted by the tool operator; and

FIGS. 14A-I illustrate a number of alternative tool heads that are illustrated as examples of Tool Heads that can be used for different tasks.

### DETAILED DESCRIPTION

The following detailed description describes various features and functions of the disclosed systems and methods with reference to the accompanying figures. The illustrative system and method embodiments described herein are not meant to be limiting. It may be readily understood that certain aspects of the disclosed systems and methods can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### Definitions

As used herein, the term “Prior Disclosure” represents the disclosure titled “Impacting Device with Adjustable Impact Energy, Elongated Body, or Configured as an Attachment to a Drill or Lawn Trimmer” that was filed January 25, 2024, at the United States Patent and Trademark Office, Application Number 63/625,012.

All definitions set forth in the prior disclosure are incorporated herein by reference in their entirety, and may be superseded by any definitions provided herein .

As used herein, the term “powering device” describes a device that can turn a drive shaft that is connected to the impacting device. A powering device may comprise a motor and a power source or another means to turn the impacting device drive shaft. Examples of powering devices include drills or lawn trimmers but can be any device that can turn a drive shaft of the impact device.

As used herein, the term “stroke length” refers to the displacement of a striker during the device's impact cycle. In device configurations without a striker, “stroke length” instead denotes the displacement of a spring from its highest energy position to its lowest energy position under normal operating conditions. This displacement corresponds to the distance the spring ends travel while storing or releasing energy during the impact cycle.

As used herein, the term 'maximum stroke length' refers to the longest stroke length achievable by the device when configured for its greatest stroke length. For devices with adjustable stroke lengths, the maximum stroke length corresponds to the configuration providing the longest possible stroke.

As used herein, the term "operator adjustable" refers to a feature or mechanism of a tool or device that allows the person operating the tool to make adjustments to its settings, configurations, or functionality during normal operation without requiring disassembly of the tool or the use of additional tools or components. Furthermore, the term "operator adjustable" excludes any adjustments that require changes to the power source, such as replacing or recharging a battery, modifying an electrical power supply, or altering the pneumatic air pressure. The adjustments must be achievable directly through the tool’s built-in mechanisms or controls, ensuring seamless operation without interrupting the tool's primary functionality.

As used herein, the term “air strike” describes a condition where the impact energy from the impacting device does not propagate into a target. This condition requires that the impact energy is absorbed by the impacting device. Stresses on the impacting device from an air strike can be high and may in some cases cause damage to the tool or property.

As used herein, the term “push to activate” refers to a feature where the impacting device will not begin storing energy until the tool head is pushed into the target. This activation may be triggered by a mechanical element (e.g., a spring-loaded anvil as described within) or an electrical component (e.g., a sensor or switch) that detects engagement with the target. One benefit of this “push to activate” functionality is the reduction in the likelihood of an air strike, since the device will only activate once the tool head is firmly in contact with—or sufficiently close to—the target.

As used herein, the term “barrel cam” describes a type of cam. A barrel cam is a cylindrical cam in which the follower rides on the surface of a cylinder. In the most common type, the follower rides in a groove cut into the surface of a cylinder. The groove is also known as the track. The track in a barrel cam can extend for more than one rotation of the follower.

As used herein, the term “top trigger” describes a component that sets or establishes the top position for the stroke of the striker. By adjusting the top trigger's position, the striker's stroke length can be adjusted. Adjusting the stroke length is desirable to set an appropriate amount of impact energy for a particular impact device application or impact device task.

As used herein, the term “upstroke” describes the portion of the impact cycle when the striker is moving away from the anvil, and the spring is accumulating stored energy.

As used herein, the term “downstroke” describes the portion of the impact cycle when the striker accelerates toward the anvil and the spring releases stored energy.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

As used herein, the term “target,” is meant to describe the object intended to receive the impact energy. For example, when cleaning snow and ice off sidewalks, the target would be the snow or ice. In the example of digging post holes, the target would be the ground in which the hole was being dug. In the example of demolition, the target would be the object being demolished. Example targets used in the description include snow, ice, ground and earth, but other examples include walls, flooring, ceiling, roof, roads, piping, wiring, cement, metal, wood, plastic, or any other similar object or article intended to receive impact energy from an impacting tool.

As used herein, terms “housing,” “tool body housing,” “tool housing”, “device housing”, and “elongated housing” refer to the substantially same structural component of the device. Unless otherwise indicated, all references to a “housing,” “tool body housing,” “tool housing,” “device housing,” or “elongated housing” refer to any and all components of the enclosure that at least partially contains or encloses the impacting mechanism components. As used herein, “impacting mechanism components” includes any striker, cam, spring, and anvil configured to transfer impact energy. For purposes of defining the housing enclosure, the tool holder, tool head, gearbox, drive shaft, and motor are not considered part of the impacting mechanism.

However, as those of ordinary skill in the art will recognize, alternative housing and/or enclosure configurations may be utilized as well. As just one example, this housing may also support or protect additional internal components related to the device’s operation.

As used herein, the term “tool head” describes the portion of the tool that impacts the target. It is the operative tool end and is sometimes called the effector. This contrasts with the “tool holder,” which is meant to be the portion of the tool that holds the “tool head.” A tool holder can be configured to attach a tool head, either permanently or interchangeably. If the tool holder is configured to attache a tool head interchangeably, then by removing one tool head from the tool holder, the tool holder will then be able to receive a different tool head. Someone skilled in the art will recognize that many different types of tool heads are possible. Some examples of tool heads, without limitation to these examples, are chisels (flat chisels, scaling chisels, point chisels, earthwork chisels, etc.), punches (center punch, pin punch, etc.), scrapers, splines or forks (like pitchforks, pickle forks, or sheep shears), cutting tools nail guns, scoops, shovels, chippers, axes, bushing tools, ground rod drivers, post drivers, diggers, tampers, hoes, picks, cutting tools, saws, crowbars, come-along, ratchets, wrenches, bolt cutters, nail puller, pipe reamer, a post hole digger, including impact wrenches. One unique tool head, that is particularly effective for ice and packed snow is a cutting shear like a sheep shear or hair shear.

As used herein, the terms “spring” or “biasing member” refer to one or more mechanical components configured to store and release energy for generating the impact energy. The spring will store energy from the power source and then release it as a burst of energy, generating impact energy, before it cycles back to storing energy. As those of ordinary skill in the art will recognize, alternative spring and biasing arrangements may also be utilized. Examples of springs or biasing members may include compression, extension, spiral, disc, torsion, leaf, pneumatic and other type of springs as the application requires. For example, a pneumatic spring uses pressurized gas to generate a force and store energy. A common configuration of a pneumatic spring is an air cylinder spring, which can be relatively lightweight, reliable and cost-effective. Different spring types, such as coil springs, pneumatic springs, or other mechanical energy-storing elements, may be used in combination to achieve the desired performance and geometry characteristics of the spring.

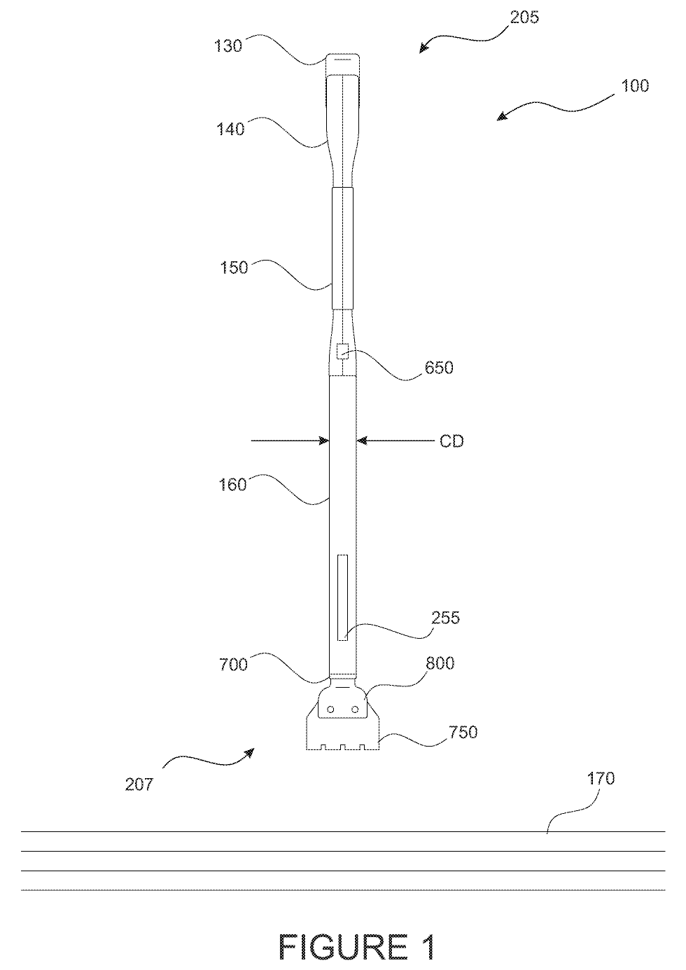

As used herein, the term “power source” describes the origin of the energy for the device. This energy will provide power that is required to impact the target. Without loss of generality, the power source, for example, could be a battery (Shown in FIG. 1 as 130), or it may comprise an electrical power cord, a fuel-burning engine, pneumatic air power, or other similar or like power sources.

As used herein, the term “drive shaft” refers to the shaft that delivers energy from the power source to the impact mechanism. The term “inner shaft” is one specific example of a drive shaft illustrated in the figures and described in the description.

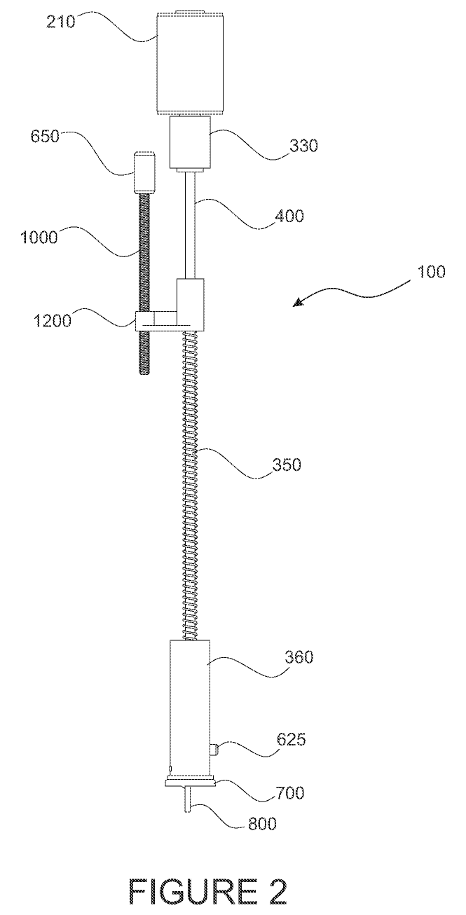

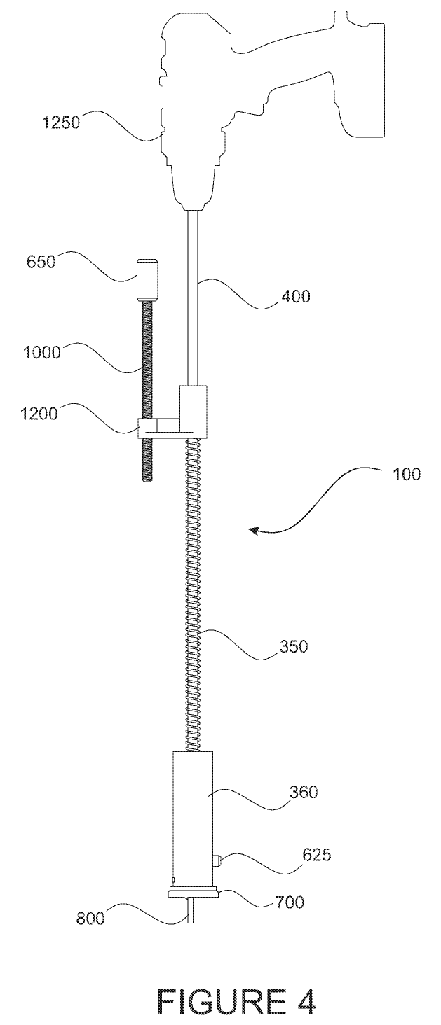

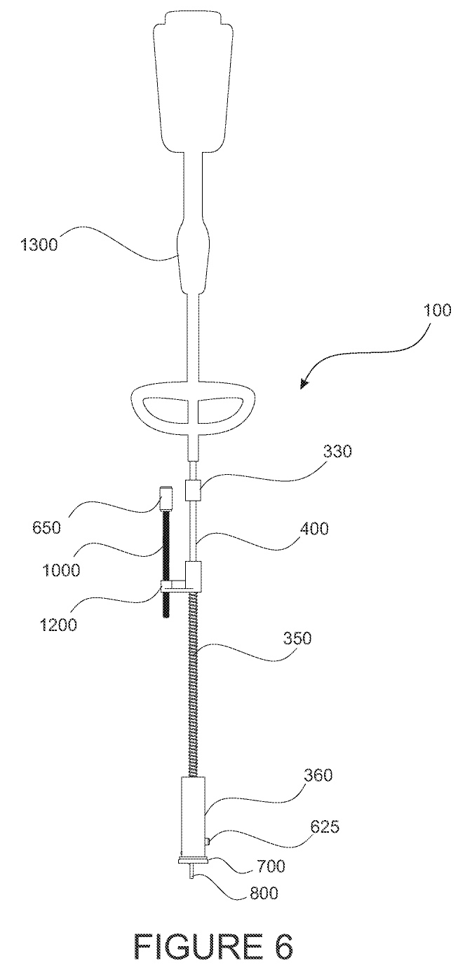

As used herein, the term “preload” refers to energy stored in the spring at its minimum energy level. The preload is sometimes equivalently measured by force on the spring at the minimum energy level, or by the distance at which the spring is activated at the minimum energy level. For example, if the spring type is a compression spring, the stroke adjust knob 650 shown in FIG. 2, FIG. 4, and FIG. 6 allows a user to increase the amount of preload within the spring 350 by compressing the spring. If the spring type comprises an extension spring, the stroke adjust knob 650 may allow a user to increase the amount of preload in the spring by extending the spring.

As used herein, the term “characteristic dimension” of a device housing refers to a representative measure of the housing’s principal cross-sectional extent. For a substantially cylindrical housing, the characteristic dimension is the diameter of the cylinder. For example, FIG. 1 illustrates the characteristic dimension of the housing 160 of the impact tool 200 as “CD.” For a housing having an irregular or otherwise non-cylindrical cross-section, the characteristic dimension is defined as the square root of the cross-sectional area, measured in a plane normal to the housing’s longitudinal axis.

The term 'minimum characteristic dimension' is determined by examining the housing’s primary or functionally significant cross sections and specifically excludes terminal or transitional regions where the housing tapers to a dimension less than 5% of the housing’s maximum characteristic dimension. These excluded regions are defined as portions of the housing that are negligible or purely transitional and do not contribute substantially to the functional characteristics of the housing. As a result, the minimum characteristic dimension is defined as no less than 5% of the housing’s maximum characteristic dimension, even if the housing tapers gradually at its extremities.

As used herein, the term “long stroke length” refers to any stroke length that (1) exceeds the minimum characteristic dimension of the device housing (which at least partially contains or encloses the impacting mechanism), or (2) is greater than approximately two inches (about 5 cm). This definition ensures that any stroke length meeting either criterion is regarded as “long” for the purposes of this disclosure.

As used herein, the term “reach” refers to the distance from the target to the furthest portion of the handle. In other words, when the tool head is positioned against or in contact with the target, “reach” is measured from the target to the outermost point on the handle that an operator would grasp or hold. This measure illustrates the tool’s maximum extension from the impact site to the operator’s grip.

As used herein, the term “long reach design” refers to a configuration in which the reach of the tool—i.e., the distance from the target to the furthest point of the handle—exceeds three times the length of a standard tool head. This ratio ensures that the operator handle remains significantly farther from the target compared to the length of the tool head, providing enhanced reach and potentially improving control, stability, and ergonomic benefits.

As used herein, a 'standard tool head' refers to a tool head that conforms to dimensions, configurations, and functional characteristics commonly recognized as conventional or widely used for the intended application in comparable devices. In cases where there is significant variability among tool heads, a 'standard tool head' is defined as one that meets the following criteria: (1) it is designed to interface with the device without requiring custom adapters or modifications; (2) its length falls within the range typically observed for the majority of tool heads used in similar applications; and (3) it is capable of performing the intended function under standard operating conditions without exceeding design limitations of the device.

### The Impacting Device/Tool

FIG. 1 illustrates an impact tool 100 that comprises a power source. For example, FIG. 1 shows the target 170 of the tool 100. The target 170 may comprise an object intended to receive impact energy from the tool or device. For example, the target 170 may receive impact energy from the impact tool 100 using the attached tool head 750.

FIG. 1 is an illustrative drawing of the external view of an impacting device. FIG. 2 illustrates the internal or cross-sectional view showing the key assemblies inside this impacting device. In FIG. 1, a battery acts as the power source 130 and powers the motor 210, shown in FIG. 2. When the power source 130 is energized, the repeated motion of the striker cam assembly 360 (shown in FIG. 2) strikes the anvil assembly 700, causing tool holder 800 to drive the tool head 750 to be intermittently inserted into a designated target 170 (e.g., FIG. 1, ice or snow) with impact energy. This intermittent action propelled by the impact tool 200 can provide sufficient impact energy to cause the efficient breaking up of or removal of ice by way of the movement of the tool 100 as described in detail herein.

### Housing and Drive Shaft

As illustrated in FIG. 1, the impact tool 100 comprises a housing 160. This housing 160 is configured to contain the internal impacting mechanism. The internal mechanism is shown in more detail in FIG. 2. Illustrated in FIG. 1, the housing extends from the first end near the top of the tool holder 800; to the second end below the grip 150. The grip 150 may comprise one or more human interface components 650 (i.e., buttons, triggers, knobs, switches, on/off controls) that allow for the control and operation of the impact tool 100.

The elongated housing illustrated in FIG. 1 exemplifies a “long reach design,” because it provides a reach exceeding three times the length of a standard toolhead, thereby enabling a substantially extended reach while still retaining a short toolhead. This allows the operator to stand further away from the striker and anvil while it is impacting. Current impacting tools have a short and compact body, where the toolhead is close to the power source. Current impacting tools use a long and heavy tool head for the operator to achieve a long reach. The elongated housing has several advantages over current short and compact bodies because it avoids needing a long, heavy tool head to transmit the large impact force from the power source to the target. Moving the anvil and striker closer to the target makes the heavy tool head shorter and lighter, while the smaller tool head retains enough strength to withstand the impact forces. This allows the operator to reach targets further away from their position. For example, it will allow the operator to stand while reaching and using the tool on the ground without needing a long, heavy tool head. Another example is allowing the operator to stand a safe distance from a wall being demolished by the impacting tool without needing a long and heavy tool head. As those of ordinary skill in the art will recognize, alternative arrangements may also be utilized to position the striker and impact energy source close to the target without requiring the operator grip to be close to the target or to use a long tool head.

Referring back to FIG. 1, in this illustrated arrangement, the housing may further be coupled to a grip 150 to allow a user to properly grip the impact tool. This tool, grip 150, can serve several beneficial functions. As those skilled in the art will recognize the grip 150 may be integral with the housing 160. For example, this grip 150 can be configured to provide improved control of the impact tool 100. This grip 150 on this impact tool 100 may also provide the user with a more secure and comfortable grip on the impact tool 100, allowing users to maintain better control while using or manipulating the impact tool 100. This can help prevent the impact tool 100 from slipping or moving unexpectedly during use, which can be particularly important when working with powerful tools while also using the tool in challenging environments, such as in a cold, windy, snowy, or icy environments and/or conditions. Those of ordinary skill in the art will recognize that there are multiple possible arrangements for grips, including footrests at the end tool, and handles in the middle of the elongated body.

In addition, this grip may also be configured or designed so that it incorporates one or more shock-absorbing features. As just one example, such a shock-absorbing feature may comprise a spring or elastic polymer to reduce the effects of impacts on the operator.

### Viewing Window

As illustrated in FIG. 1, the housing 160 may comprise a viewing window 255 in one preferred arrangement. As just one example, the viewing window 255 may allow an operator of tool 100 to view one or more operational components of tool 100. For example, as just one example, the viewing window 255 may be configured to allow the user to view various components of the striker cam assembly 360, such as a striker 500, a biasing member (a spring) 350, and an inner shaft 400 (FIG. 2). Such viewing may occur during spring storing energy and during the spring’s release of stored energy, thereby providing one possibility to gauge proper tool operation. As those of ordinary skill in the art will recognize, alternative viewing window arrangements may also be utilized.

### Tool Holder

The operating tool end comprises a tool head 750 operatively coupled to a tool holder 800. The tool holder 800 is operatively coupled to an anvil defined by the distal end of the housing 160. The tool holder can be configured to hold different tool heads as the application requires. In certain applications, the tool holder may need to be designed to endure prying or torque forces.

The tool holder 800 may be user-releasable or non-releasable. In this illustrated arrangement of FIG. 1, the tool head 750 comprises an ice breaking tool head for use with braking up ice and/or compacted snow. However, alternative tool head arrangements and tool end effectors may be utilized in alternative arrangements.

### Tool Head

More specifically, and as illustrated in FIG. 1, the tool head 750 is operatively coupled to the tool holder 800 in a releasable manner. As those of ordinary skill in the art will recognize, there are multiple alternative means for fastening the tool head to the tool holder so that it is secure and convenient for the operator to replace the tool end. The tool head 750 in FIG. 1 is shown as an ice-breaking tool head for use in breaking up ice and/or compacted snow, but as described in the tool head definition, it could be any type of tool head.

In one arrangement, the operating tool head 750 may be interchangeable. For example, such interchangeable tool heads allow for different types of tool heads 750 to be removably coupled to the tool holder 800. Example tool heads are described in the tool head definition and may, without limitation, comprise powered shovels, hammers, mallets, sledge hammer, pliers, scrapers, flat chisels, scaling chisels, point chisels, nail gun, scoop, punches (center punch, pin punch), splines or forks like a pitchfork, chippers, axes, bushing tools, ground rod drivers, shovels, earthwork chisels, diggers, tampers, hoes, picks, cutting tools, saws, crowbars, come-along, ratchets, wrenches, bolt cutters, nail puller, pipe reamer, post hole digger, including impact wrenches, or other similar type tool end effectors that could utilize an impact tool as herein described and explained.

### Impact Mechanism near Target

In one arrangement, illustrated in FIG. 1 and FIG. 2, the impact mechanism of the device is located near target (170 of FIG. 1), thereby positioning it closer to the second (distal) end 207 of the tool. By placing the impact mechanism near the target, the high forces associated with impact energy are transmitted over a shorter distance compared to existing devices in which the impact mechanism is placed near the first (proximal) end 205. This arrangement supports a "long reach design," permitting an extended reach from the handle to the target while still retaining a short toolhead. The tool head to be constructed with reduced mass, size, and cost relative to conventional designs. In contrast, existing devices typically position the impacting mechanism closer to the motor 210 (FIG. 2) and first end 205 (FIG. 1), than to the target 170. This necessitates a heavier, larger, and more expensive tool head.

Additionally, because the impact mechanism is closer to the target 170, and reduces the overall device weight, the operator handles and grip 150 may be located farther from target 170, improving operator comfort, reach, stability, and safety. In some embodiments, this disclosed configuration can significantly reduce the device's overall weight and cost, while further enhancing ease of use by distancing the user’s grip from the high-impact area.

In some embodiments, the tool geometry is configured to have a “long reach design” such that the distance from the operator handle(s) to the target is significantly larger than the distance from the target to the tool holder. Specifically, when the tool head touches the target, the longest distance from an operator handle to the target is more than three times the distance from the target to the tool holder. This arrangement ensures that the impact mechanism is located closer to the target rather than near the motor or operator handle. As a result, the tool head can be made smaller and lighter, reducing overall mass at the impact site while still providing sufficient reach for the user. By situating the impact mechanism near the distal end—close to the target rather than the motor—the device can better localize the impact force, improve precision, and reduce unnecessary weight in the tool head

### Stroke Adjust Knob

A novel feature of this impacting device is the ability to adjust the impact energy per stroke. FIG. 1, and FIG. 2, illustrate one way to adjust the impact energy per stroke, which is by adjusting the preload of the spring by using the stroke adjusting knob 650. The preload is the amount of energy stored in the spring at its minimum energy level. The preload is sometimes equivalently measured by force on the spring or by the distance at which the spring is activated. For example, if the spring type comprises a compression spring, the stroke adjust knob 650 allows a user to increase the amount of preload within the spring 350 by compressing the spring. If the spring type comprises an extension spring, the stroke adjust knob 650 may allow a user to adjust or increase the amount of preload in the spring by extending the spring. In this example, the amount of preload in the spring is adjusted by moving the position of a retaining ring that abuts the compression spring on one end. Changing the length of the spring will change the force and energy stored in the spring. In one arrangement, changing this spring pre-load does not directly change the device's impact rate but will change the impact energy per stroke. In one arrangement, this spring preload setting may be user settable. In another arrangement, this feature may not be user-settable and may only be permanently configured by the manufacturer or the provider of the impact tool 100. However, as those of ordinary skill in the art will recognize, alternative means exist for preloading springs. Extension springs can be preloaded through extension. Pneumatic springs can be preloaded by controlling minimum gas pressure. In another arrangement, multiple springs can be used to store and release impact energy. As those of ordinary skill in the art will recognize, there are many alternative means to adjust the preload of a spring, and FIG. 1 and FIG. 2 show just one exemplary means.

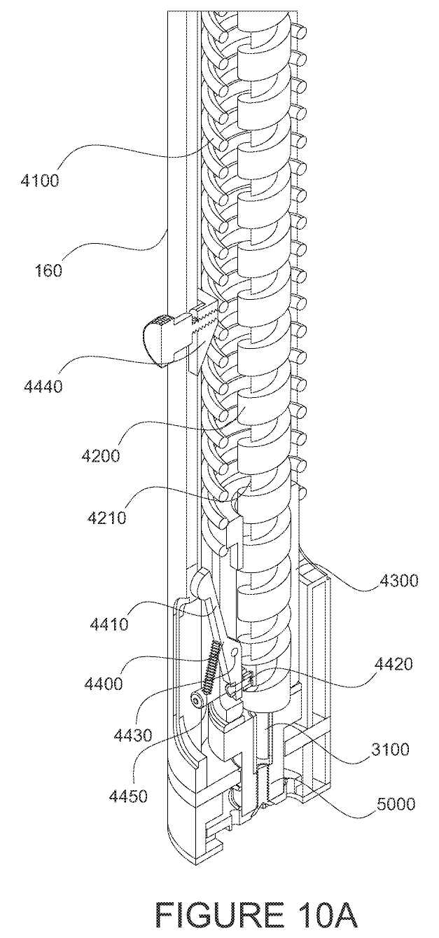

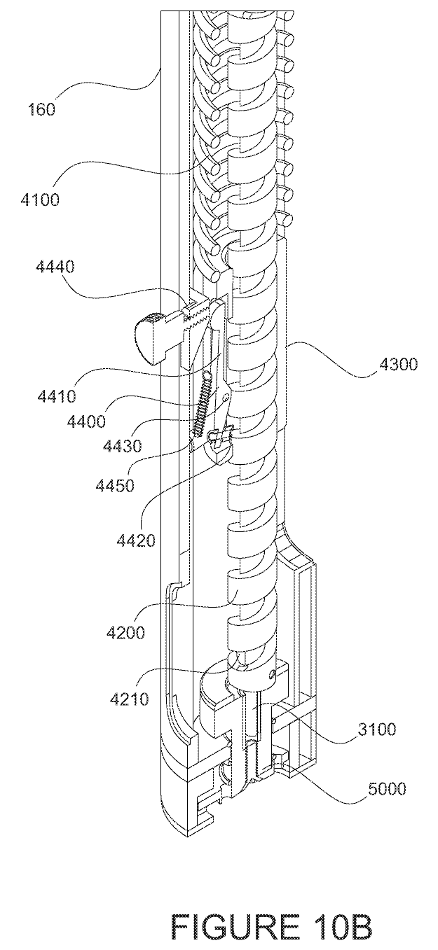

As just one example, another way to adjust the impact energy per stroke is to adjust the stroke length of the striker. One illustrative example of this is shown in FIG. 10b where the position of the adjustable top trigger 4440 can be adjusted by the operator to adjust the stroke length of the striker.

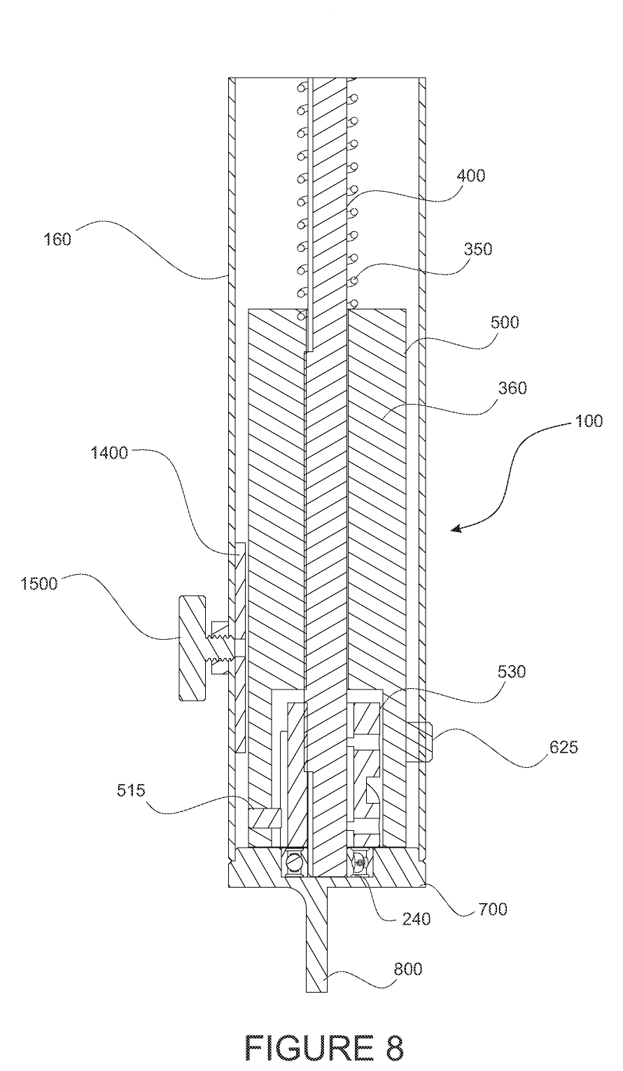

Another way to adjust the impact energy per stroke is to adjust the friction against the striker on the down stroke. FIG. 8 shows one means of adjusting the impact energy per stroke by adjusting the friction to knob 1500. In this illustrated arrangement, the knob 1500 extends through the housing 160 and into a friction plate 1400. Screwing the knob 1500, moves the friction plate 1400 into the striker 500 is one way to control the friction and therefore control the impact energy per stroke. As those of ordinary skill in the art will recognize, there are many alternative means to add friction to the system to control the impact energy per stroke. An alternative example is to restrict the speed of the striker in the downstroke, by trapping air below the striker, and control the release of this air through a control valve, which dissipates energy as the air moves through the valve while the striker is in the downstroke.

### Power source

The impact tool 100 further comprises a power source 130, such as a battery (FIG. 1). In one preferred arrangement, this power source 130 is positioned near the first end 205 of the impact tool 100 (FIG. 1). In one preferred arrangement, this battery 130 comprises a removable, rechargeable battery such as a lithium-ion battery. However, as those of ordinary skill in the art will recognize, the impact tool 100 may utilize alternative power source arrangements. In one example of an alternative arrangement, this power source 130 may comprise an electrical extension cord that is connected to an electrical circuit. In yet another example, in one alternative arrangement, this power source 130 may comprise a motor powered by fuel.

### Tool Internal Components

FIG. 2 illustrates a cross-section view of several operating components of an impact tool 100 illustrated in FIG. 1.

Referring now to FIG. 2, the impact tool 100 in a first arrangement comprises a motor 210. In one preferred arrangement, the motor 210 comprises an motor 210 and is operated by the power source (e.g., a battery) 230. In this arrangement, motor 210 is illustrated as being positioned near the first end 205 of impact tool 200. However, as those of ordinary skill in the art will recognize, alternative motor locations within the impact tool 200 may also be utilized. For example, in an alternative arrangement, the motor 210 may be being positioned in between the first end 205 and the second end 207 of the impact tool 200.

According to an exemplary arrangement, the impact tool 100 comprises an inner shaft 400 and a spring 350. In one preferred arrangement, the spring 350 may be positioned around the inner shaft 400, near the second end 207 of the impact tool 100. As shown in FIG. 2, the inner shaft 400 essentially extends along the length of the impact tool 100. In one arrangement, the impact tool 100 comprises a motor 210 that is operably coupled to the inner shaft 400. In one arrangement, when this motor 210 is energized, the motor 210 rotates the inner shaft 400 and the cam 530 (illustrated in FIG. 8), since the cam 530 is operably coupled to the inner shaft 400. In one arrangement, illustrated in FIG. 2, a gear reducer 330 can be utilized wherein this gear reducer 330 could be configured to be operably coupled between the motor 210 and the inner shaft 400 thereby reducing the overall rotational speed and increasing the torque of the inner shaft 400 with respect to the speed of the operating motor 210 By increasing the inner shaft’s torque, a larger amount of energy can be stored in the spring per rotation, thereby raising the impact energy delivered per strike. One or more bearings may be provided in the housing 160 to facilitate the rotation of the cam 550 and the inner shaft 400.

### Spring and Preload

In one arrangement, the spring 350 is not affixed or attached to the inner shaft 400 such that when the inner shaft 400 is rotated, the spring 350 will not rotate during the activation of the impact tool 200. In one preferred arrangement, the spring 350 comprises a compressible spring. However, as those of ordinary skill in the art will recognize, alternative spring arrangements and spring configurations may be utilized as well.

In one arrangement, the spring 350 is positioned around the inner shaft 400 in a preloaded condition or state (see definition). In other words, before activation of the power source 130, the spring 350 while residing in a preloaded state will already have a store of energy to impart when the impact tool 100 is eventually activated. As just one example, the spring 350 may reside in a compressed state as the spring 350 will be compressed between an adjustable preload mechanism (FIG. 2) and the striker cam assembly 360. As illustrated in FIG. 2, when the stroke adjust knob 650 is rotated, it turns a threaded shaft 1000, which then moves the preload mechanism 1200. When the preload mechanism 1200 moves, it can add or remove preload in the spring as desired by the operator. In alternative tool configurations, other methods and constructs may be utilized to provide for a preload for a spring 350.

### Cam and Striker

In one preferred arrangement, the impact tool 100 further comprises a striker cam assembly 360 illustrated in FIG. 2. For example, FIG. 8 illustrates a more detailed cross-section view of an example striker cam assembly and is described below. As illustrated in FIG. 8, the cam 530 is operatively coupled to the inner shaft 400. The cam 530 comprises a cylindrical structure that resides within an internal cylindrical cavity defined by the striker 500. In addition, the striker cam assembly comprises a striker 500 whose internal cylindrical cavity is configured to receive both the inner shaft 400 and the cam 530. As illustrated in FIG. 8, in an assembled state, the striker 500 defines the internal cylindrical striker cavity in which the cam 550 and the inner shaft 400 resides and can rotate during the activation of the impact tool 100.

In one arrangement, the striker 500 is driven in a non-rotating manner to compress the spring 350. Compression of the spring 350 may occur for a certain predetermined amount of cam rotation before the energy in the spring is released and the striker rapidly moves towards the anvil assembly 700. The inner shaft 400 extends through both the striker 500 and the spring 350, and in this example is held in place with a bearing 240. However, as those of ordinary skill will recognize, alternative biasing member and/or drive shaft configurations may also be utilized.

In one arrangement, one end of the spring 350 is maintained or secured at a desired position along the inner shaft 400 by way of an adjustable stop or preload mechanism 1200 (FIG. 2). This preload mechanism 1200 may be configured to maintain the position of one end of the spring 350 along the inner shaft 400. In one preferred arrangement, the preload mechanism 1200 prevents the spring 350 from moving towards the first end 205 of the inner shaft 400 while also allowing rotation of the inner shaft 400 with respect to the spring 350 during activation of the impact tool 100.

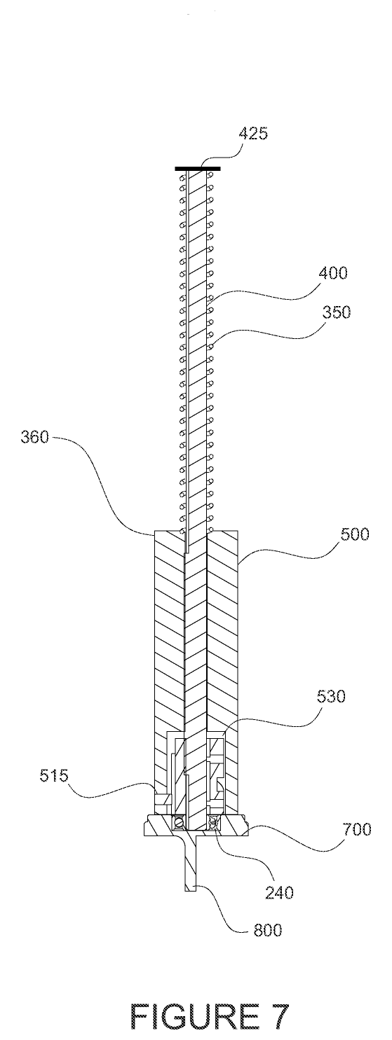

As illustrated in FIG. 2, the preload mechanism 1200 may be operatively coupled to a threaded shaft 1000 and a stroke adjustment knob 650. In this manner, the stroke adjustment knob 650 can allow for the adjustment of an amount of preload on the spring 350. Alternatively, there may not be a stroke adjustment knob 650, and instead the preload may only be adjustable by the disassembly and movement of a spring stop. In another preferred arrangement, the impact tool 100 may utilize a spring stop that is not adjustable but rather comprises a fixed spring stop. FIG. 7 depicts an example of a fixed stop 425.

### Striker Cam Assembly

FIG. 8 is a cross-sectional view of one preferred arrangement for the striker cam assembly. As can be seen from FIG. 8, a follower 515 is provided by the striker 500. This follower 515 may be configured to engage the cam 530 while the cam 530 is situated within the internal cavity defined by the striker 500.

More preferably, this follower 515 may be configured to engage a track provided by the outer surface of the cam 550 while the cam 550 is situated within the internal cavity defined by the striker 500. In one arrangement, the follower 515 comprises a follower pin. In another arrangement, the follower 515 comprises a bearing. The follower is configured to engage or ride along the track defined by the cam 530 outer surface. As the follower 515 rides up and down the track defined on the outer surface of the cam 550, the follower 515 also moves the striker up and down. In the arrangement shown in FIG. 8, when the striker moves up it compresses the compression spring 350. And when the striker moves down it releases the energy stored in the spring, which allows the striker to deliver impact energy to the anvil assembly 700. In another arrangement, the follower can follow the top surface of the cam. However, as those of ordinary skill in the art will recognize, alternative striker cam assembly and follower configurations may also be utilized.

### Anvil

FIG. 8 also illustrates a preferred arrangement for the coupling of the striker cam assembly to the anvil and tool holder. FIG. 8 illustrates an embodiment of a cam 550 attached to a distal end of the inner shaft 400. The inner shaft 400 further comprises a bearing 240 at the distal most end of the inner shaft 400. In this illustrated arrangement, the anvil assembly 700 further defines a feature that the bearing 240 is held within.

In one arrangement, the striker 500 is driven to engage an anvil assembly 700. This anvil assembly 700 is configured near the distal end of the impact tool housing 160. One advantage of this disclosed anvil arrangement is that it is sealed near the bottom. A suitable flexible seal can be advantageous in transferring the impact energy. In this manner, the sealed nature of the anvil assembly 700 prevents the ingress of moisture, water, dirt, and other potential elements and debris. As shown in FIG. 8, the tool holder 800 is operatively coupled to the anvil assembly 700.

### Energy Transfer sequence from drive shaft to target.

In one arrangement illustrated in FIG. 8, the rotation of the inner shaft 400 and, therefore, the cam 550 will cause the follower to follow the track on the cam, which causes the striker 500 to move upwards towards the spring 350. In one arrangement the spring 350 is a compression spring. This upward movement of the striker 500 will begin to compress (or further compress) the compression spring 350 as the inner shaft 400 continues to rotate. Once the follower 515 is driven a predefined length along the cam’s track, the striker 500 will be released from the cam under a force of the compression spring 350. The striker 500 will then be driven towards the anvil assembly 700. The anvil assembly 700 (shown in FIG. 8) will provide impact energy to the tool holder 800 (shown in FIG. 8 and FIG. 1) and in turn to the attached tool head 750 (shown in FIG. 1). The tool head will then provide impact energy to the target.

### Cam Track and Stroke Length

In one arrangement, illustrated in FIG. 8, the follower 515 is provided along an inner surface of the striker 500. In this manner, the follower 515 is configured to engage the track provided along an external surface of the cam 550. In one arrangement, the predefined height of this cam track defines a stroke length of the impact tool 100. Therefore, in one preferred impact tool arrangement, cams with different stroke lengths configurations may be utilized. In such situations, the stroke length of a particular impact tool 200 will be determined in part by the cam track defined by the cam 550. As such, each different cam track can result in a different stroke length.

In one preferred cam track arrangement, the stroke length is about 1 inches to about 4 inches

### Linear Guide

FIG. 8 illustrates a linear guide 625, the striker 500, and the inner shaft 400, and the housing 160. As noted, in one preferred arrangement, when the impact tool 100 is energized, the inner shaft 400 rotates. In contrast, the striker 500 does not rotate but merely moves in a linear fashion as to compress (or further compress) the spring member (i.e., the compression spring). In one preferred arrangement, the linear guide 625 and/or the impact tool housing 160 may be configured as to prevent the striker 500 from rotating.

For example, in one arrangement, the impact tool 100 illustrated in FIG. 2 comprises a linear guide 625 and this linear guide 625 can be configured to restrict the striker 500 to linear movement by engaging with a feature in the housing 160. This linear guide is configured to prevent rotation of the striker 500 and allow for only axial movement of the striker 500.

In another example, in one arrangement, the the impact tool 100 illustrated in FIG. 8 comprises a linear guide 625 and this linear guide 625 can be configured to restrict the striker 500 to linear movement by engaging with a feature in the housing 160. This linear guide is configured to prevent rotation of the striker 500 and allow for only axial movement of the striker 500.

Those skilled in the art will recognize that alternative methods exist for constructing a linear guide to prevent rotation of the striker

### Impact tool as an attachment.

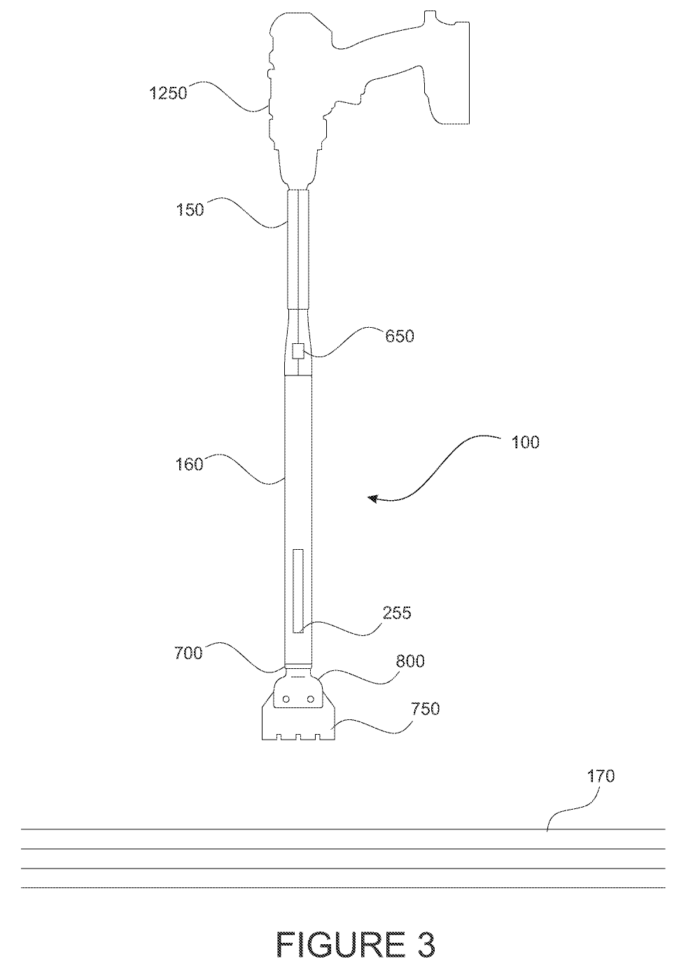

FIGS. 3 - 6 illustrate alternative arrangements of the impacting tool 100, where the impacting tool is an attachment to an existing tool, or motor driven device. An advantage of making the tool as an attachment is that it lowers the cost of the tool since the motor, drive shaft, and portions of the casing are provided by the existing tool. Another advantage is that it allows the impact tool to be used on a large variety of different existing tools. In each of these arrangements, the rotating end of the existing tool is operatively coupled to the inner shaft 400 of the impact tool.

FIG. 3 and FIG. 4 shows an illustration of how an impacting tool 100 described herein may be driven by a drill 1250. FIG. 3 is the external view, and FIG. 4 shows the internal view of key components. The rotating end of the drill is operatively coupled to the inner shaft of the impact tool. This attachment may optionally contain a gear reducing assembly that attaches to the inner shaft and the drill, so as to slow down the speed and increase the torque of the inner shaft, and enable increasing the impact energy per strike.

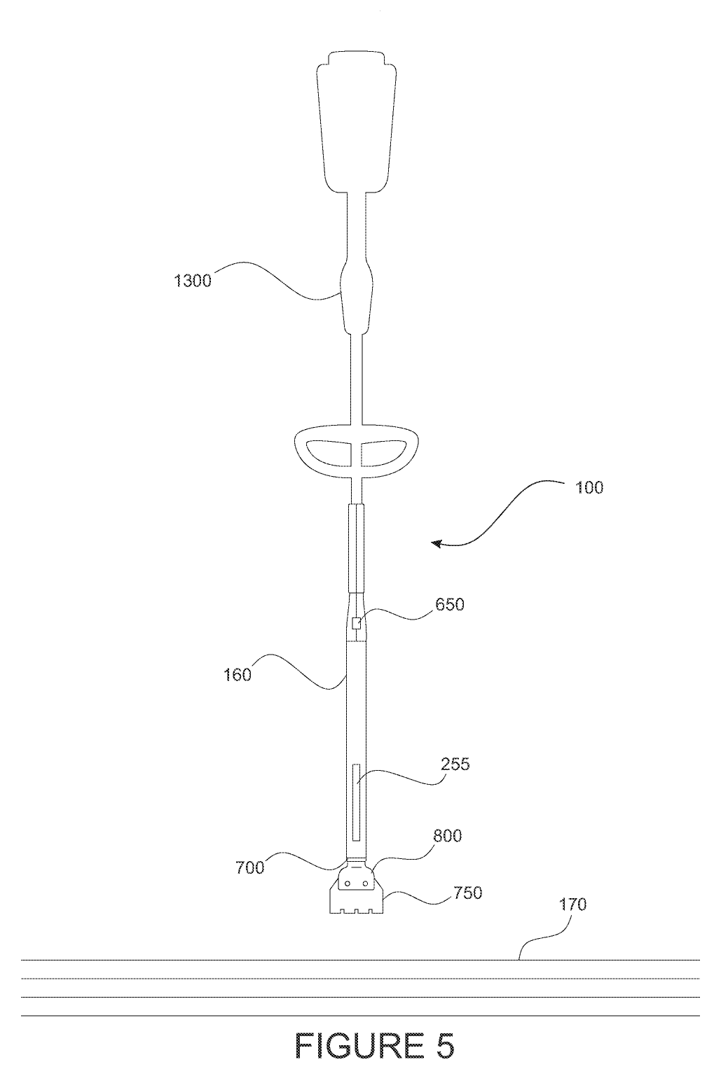

FIG. 5 and FIG. 6 shows an illustration of how an impacting tool 100 described herein may be driven by a Lawn Trimmer or Lawn Edger 1300. FIG. 5 shows an external view, and FIG. 6 shows the internal view of key components. A lawn trimmer typically has a high rotational speed with low torque suitable for lawn trimming but is not suitable for a high impact device. This gear reducer 330 reduces the rotational speed and increases torque of the lawn trimmer drive shaft before transferring the energy to the inner shaft. For a high impact device, the preferred arrangement for this gear reducer is to provide over a 20 to 1 gear reduction ratio.

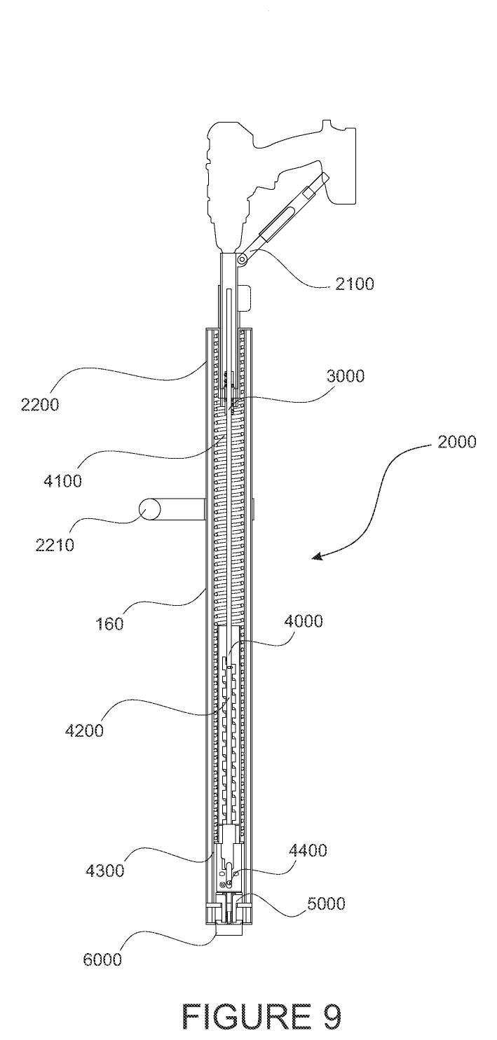

### FIG. 9 - Tool Body Assembly

FIG. 9 illustrates an alternative tool body assembly 2000 for a powered impacting device configured as an attachment to a powering device. This example of a tool body assembly 2000 comprises a powering device mount assembly 2100 which comprises a powering device and a mount for the powering device such that the powering device can turn the drive shaft 3000. The tool body assembly 2000 also comprises a tool body housing 2200 that protects the tool internals.

Optionally, one or more operator handles 2210 may be mounted on the tool body assembly 2000. In this illustrated arrangement, the operator handle extends from the tool body housing 2200. The tool body assembly 2000 further comprises an internal shaft assembly that comprises a drive shaft 3000 and associated bearings that the powering device turns. The tool body assembly 2000 further comprises a tool body internal assembly 4000 that is comprised of a main spring 4100, striker assembly 4300, cam 4200, and follower assembly 4400. Finally, the tool body assembly 2000 comprises an anvil assembly 5000 and a tool holder 6000.

In the example illustrated in FIG. 9, the cam comprises a barrel cam 4200, that extends a certain desired length from the bottom track to the top track. In one preferred arrangement, the barrel cam 4200 extends about 4 to about 18 inches from the bottom track to the top track. The length of the barrel cam 4200 can be designed to meet the needs of the application and can be either substantially shorter and/or substantially longer. A longer barrel cam enables a longer striker stroke length and potentially more impact energy per strike, and a shorter barrel cam enables a more compact and less costly design.

One purpose of the biasing member or main spring 4100 is to store energy during the striker assembly 4300 upstroke and release a burst of energy during the striker assembly 4300 downstroke. FIG. 9 illustrates an example of a main spring 4100, a compression spring outside the inner shaft extending from a position on the striker to near the top of the housing. This is just an example for illustrative purposes. Another example of a main spring 4100 is using an extension spring instead of a compression spring. The extension spring may extend from the bottom of the housing up to a position near the striker. An advantage of an extension spring versus a compression spring is that the extension spring may make the tool length shorter. However, in some impact device configurations, it may also make the diameter of the tool housing larger. Someone skilled in the art will recognize that many different types of main spring configurations are possible including compression springs, extension springs, torsion springs, pneumatic springs, and leaf springs.

A follower assembly 4400 is illustrated in FIG. 9. In this example, the follower assembly 4400 comprises a follower. When the follower assembly 4400 inserts the follower into the barrel cam track, the striker starts the upstroke. During the upstroke, energy is stored in the main spring. When the follower assembly 4400 removes the follower from the barrel cam track, the striker starts the downstroke. During the downstroke, the energy in the main spring is released into the striker as kinetic energy causing the striker to accelerate towards the anvil. At the bottom of the down stroke, the striker energy is released as impact energy into the anvil.

### FIGS. 10A and B – Impact Cycle Example

FIG. 10A illustrates in more detail one example of how the main spring 4100, barrel cam 4200, striker assembly 4300, and follower assembly 4400 may interact during the impact cycle. There are various alternative means to design the impact cycle with a barrel cam 4200 and follower with an adjustable stroke length. Two important features are to design the impact cycle so that once the follower 4420 enters the barrel cam track, the follower 4420 will remain engaged to the barrel cam track until the completion of the upstroke.

Another important feature of the design of the impact cycle is that once the follower 4420 exits or leaves the barrel cam track, the follower 4420 will not impact the barrel cam 4200 until after the kinetic energy of the striker assembly 4300 is released into the anvil assembly 5000. If the follower 4420 is not reliably held away from the barrel cam 4200 during the downstroke, and the impact energy is transferred into the follower 4420 by contacting the barrel cam 4200 unintentionally, it risks causing mechanical damage and jamming of the impact cycle.

One example of a reliable impact cycle using a follower assembly 4400 is illustrated in FIG. 10A and FIG. 10B. In the example shown in FIG. 10A and FIG. 10B, the follower assembly 4400 comprises a follower 4420, a follower linkage 4410, a follower pivot point 4430, an adjustable top trigger 4440, and a follower linkage spring 4450. As those of ordinary skill in the art will appreciate, alternative follower assembly 4400 configurations may also be utilized.

In FIG. 10A this example follower assembly 4400 is positioned at the bottom barrel cam track, the follower linkage spring 4450 will push the follower 4420 onto the barrel cam surface and later into the barrel cam track. Once the follower is in the barrel cam track, the striker starts the upstroke. One skilled in the art will recognize that it is possible to arrange the geometry of the follower assembly 4400 such that the force of the main spring 4100 will push and hold the follower into the barrel cam track on the upstroke.

In the example illustrated in FIG. 10B, the striker assembly 4300 will continue to rise on the upstroke until the striker assembly 4300 reaches the adjustable top trigger 4440. In one preferred arrangement, the adjustable top trigger 4440 is operator adjustable. That is, the device operator can set the adjustable top trigger 4440 position such that the stroke length and impact energy can be adjusted based on the current task at hand. In the example illustrated in FIG. 10B, the adjustable top trigger 4440, will make contact with the follower linkage 4410, and cause the follower linkage 4410 to rotate around the follower pivot point 4430. Rotation of the follower linkage 4410 around the follower pivot point 4430 will pulls the follower 4420 out of the barrel cam track 4210. This will cause the striker assembly 4300 and follower assembly 4400 to start accelerating towards the anvil assembly 5000 and start the downstroke.

In the example illustrated in FIG. 10A and in FIG. 10B, the follower assembly 4400 is configured such that when the striker assembly 4300 and follower assembly 4400 start accelerating towards the anvil assembly 5000, the follower 4420 will be held out of the barrel cam track by the dynamic forces caused by the acceleration on the follower assembly 4400. Someone skilled in the art will recognize that many possible configurations are possible for the follower linkage 4410, follower 4420, and follower pivot point 4430 such that a rapid acceleration downward at the follower pivot point can cause the follower linkage and follower to overcome the inward force of the follower linkage spring and rotate the follower assembly away from the barrel cam track. This can be accomplished by configuring the follower assembly 4400 dynamic acceleration forces, center of gravity, mass, and rotational moment of inertia around the follower pivot point 4430 to overcome the force generated by the follower linkage spring 4450.

At the bottom of the downstroke, the striker assembly 4300 will engage or hit the anvil assembly 5000, which, in normal operation, causes the energy stored within the main spring 4100 to pass from the anvil assembly 5000 through the tool holder 6000 (FIG. 9), into the tool end, and therefore into the target.

After the downstroke energy is transferred out of the striker assembly 4300, the striker assembly 4300 will not be accelerating downwards. The follower linkage spring 4450 can then be configured to push the follower 4420 in towards the barrel cam 4200 because there are no acceleration forces to overcome. This will cause the follower 4420 to push on the surface of the barrel cam 4200. When the barrel cam bottom track is aligned with the follower 4420, the follower linkage spring 4450 will push the follower 4420 into engagement with the barrel cam track 4210, and the upstroke will begin. The impact cycle can then be repeated.

### FIGS. 10A and B: Stored Energy Auto Discharge for Safety

Another optional safety feature of the barrel cam 4200 and follower design is that the device can be configured to release energy stored in the main spring when the device is not in use. This can be done by configuring the pitch of the barrel cam 4200, the force of the main spring 4100, and the friction of the follower 4420 such that the drive shaft or inner shaft 3100 will rotate backwards, such that the energy stored in the main spring 4100 will be released when the impact device is not in use. One advantage of this feature is that the energy will not be stored in the spring when the impacting device is not in use and will not cause unintended strikes.

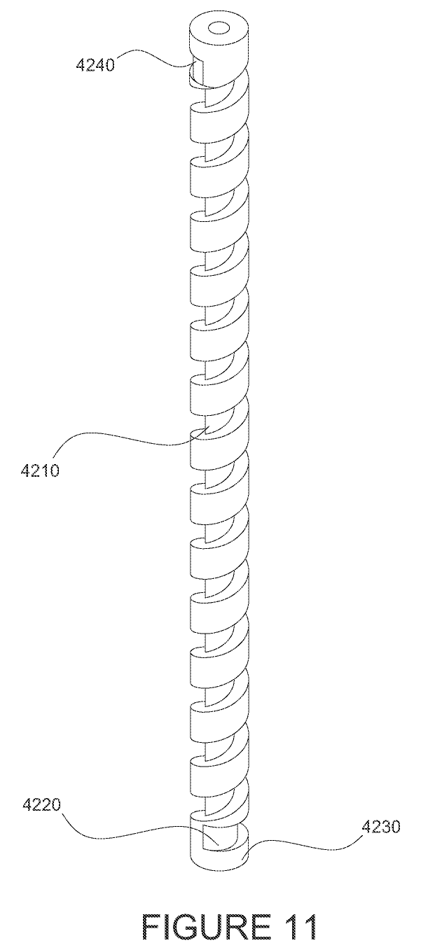

### FIG. 11: Push to Activate

FIG. 11 is an illustrative example of a barrel cam design that supports the push to activate 4230 feature, and reverse drive shaft protection 4220 features. In this alternative arrangement, the barrel cam push to activate 4230 feature is illustrated in at the bottom of the barrel cam 4200 in FIG. 11. An illustrative feature is that the bottom of the track is elevated above the bottom of the barrel cam. By designing the barrel cam track this way, it is possible to design the anvil such that when the device operator pushes the tool end into the target, this will move the striker and follower assembly upwards such that the follower is then aligned with the bottom barrel cam track. If the operator does not push the tool end into the target, the striker and follower assembly will be below the bottom track, the follower will remain on the barrel cam surface, and the impact device will not start the upstroke. By using this feature, it reduces the chance of an airstrike by setting conditions at the stroke start where the impact energy can be transferred into the target.

### FIG. 11: Reversed drive shaft protection

The barrel cam in FIG. 11 illustrates an apparatus and method to protect from an unintentional reversed drive shaft. In this illustration it can be seen that if the follower is at the level of the bottom barrel cam track, but the drive shaft is driven in the reverse direction, the follower will be forced out of the barrel cam track, and there will be no damage to the follower assembly. This barrel cam track 4210 reverse protection feature 4220 may be achieved by sloping the end of the end of the barrel cam track 4210. This is because when the follower is the barrel cam track while the barrel cam is rotating in the reverse direction, the barrel cam track slowly rises from the track full depth, to the surface of the barrel cam. There is no abrupt change that would cause the follower to get jammed.

### Over Rotation Protection

FIG. 11, feature 4240 illustrates a barrel cam design that ensures that the follower is removed from the track if the follower reaches the top of the barrel cam.

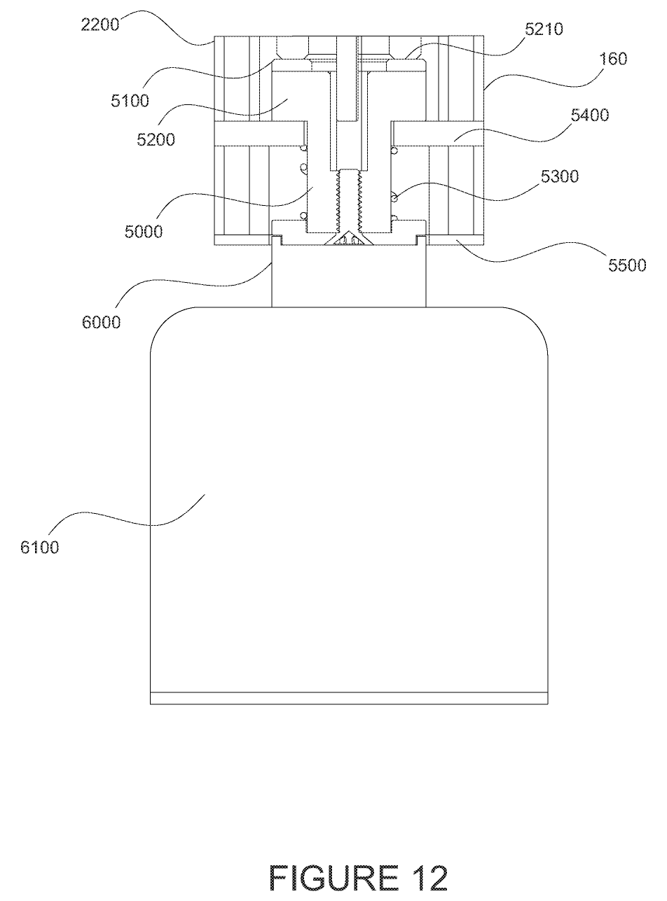

### FIG. 12: Anvil Assembly

FIG. 12 is one example of an anvil assembly 5000 that supports push to activate, noise reduction, and impact isolation features.

### FIG. 12: Anvil Noise Reduction

The example anvil assembly 5000 illustrated in FIG. 12 comprises an optional anvil rubber noise gasket 5100. In this example, the anvil rubber noise gasket 5100 is placed between the anvil core 5200, and the position where the striker strikes, the anvil core striker impact point 5210. The rubber gasket is configured to absorb a portion of the high frequency impact noise caused by metal-on-metal impacts. This reduction of the noise can be an important feature. The anvil noise rubber gasket 5100 may be attached to either the anvil or the striker.

### FIG. 12: Impact Isolation

The example anvil assembly 5000 illustrated in FIG. 12 may also comprise an anvil core 5200. The striker assembly 4300 (FIG. 11 A and B) will impact the top of the anvil core 5200 at the anvil core striker impact point 5210. The anvil core 5200 is operatively coupled to the tool holder 6000 so the impact energy from the striker assembly 4300 will flow through the anvil core 5200 and into the tool holder 6000, the tool end, and ultimately into the target without passing into the tool housing. This impact isolation feature isolates the impact energy from the tool housing.

### FIG. 12: Anvil Push to Activate

Referring to FIG. 12, in one arrangement, the anvil assembly 5000 comprises an anvil compression spring 5300 situated between the anvil core midplate 5400 and a bottom feature of the anvil core 5200. In one preferred arrangement, the anvil core bottom plate 5500 and anvil casing mid plate are both attached to the tool body housing 2200.

When the anvil compression spring 5300 is extended, it causes the anvil core 5200 to rest on the anvil core midplate 5400. The anvil core 5200 is not however attached to the anvil core midplate 5400 or the anvil core bottom plate 5500. When the anvil compression spring 5300 is extended, the striker assembly 4300 and follower 4420 (FIGS. 10A and B) will rest below the bottom of the barrel cam track. This condition will prevent the impact device from initiating an upstroke.

When the tool end 6100 is pushed into the target 170, this action will cause the tool holder 6000 and anvil core 5200 to push up. When the anvil core 5200 pushes up, the anvil compression spring 5300 will become compressed. If the striker assembly 4300 and follower assembly 4400 will remain engaged to the anvil core 5200, are at the bottom of the downstroke, then the striker and follower assembly will also be pushed up. FIG. 10A illustrates an example configuration such that when the striker assembly (4300) and follower assembly (4400) are pushed up, it can allow the follower 4420 to align with the bottom track of the barrel cam 4200, which can then allow the follower 4420 to enter into the bottom barrel cam track and the striker assembly 4300 and follower assembly 4400 will start the upstroke. An advantage of this push to activate feature is that it helps to ensure that the impact tool is pushed into the target before the upstroke is initiated. Such a safety feature can help to minimize a potential risk of an airstrike.

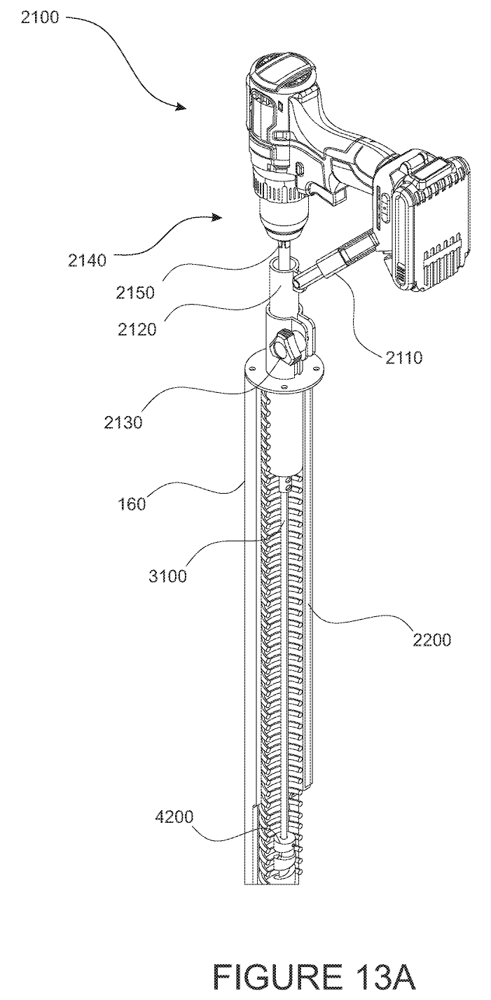

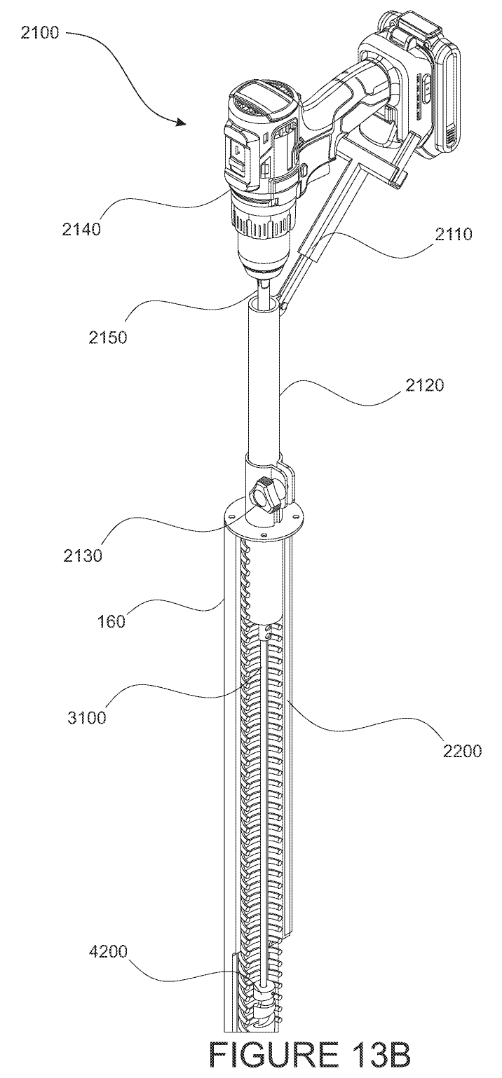

### FIGS. 13A and B: Powering Device Mounting Assembly

FIGS. 13A and B illustrate one example of how to mount the powering device 2140 such that it supports the features of adjustable tool length, and an adjustable mounting angle. The powering device mount assembly 2100 illustrated in FIGS. 13A and B is comprised of a mounting bracket 2110 that holds the powering device 2140. The powering device mount assembly 2100 is also comprised of a mount assembly shaft 2120. During operation of the impacting device, this powering device shaft 2150 is operatively coupled to the powering device 2140 in such a way that the powering device can rotate the powering device shaft 2150. The powering device shaft 2150 is operatively coupled to the inner shaft 3100, which then powers the impacting device.

### FIGS. 13A and B: Adjustable Tool Length

As illustrated in FIG. 13A and FIG. 13B, the powering device mount assembly 2100 allows for the adjustment of the tool length. FIG. 13A shows the tool length adjusted to be shorter than the tool length shown in FIG. 13B. The benefit of tool length adjustment is that the impacting device operator can change the tool length to best suit the operator size, and the conditions for the job. A taller operator may want to extend the length of the impacting device. A task that requires working in a small area, such as removing tile from a bathroom, may require the impacting device be configured to a shorter overall length.

The powering device mount assembly 2100 illustrated in FIGS. 13A and B illustrates one example of making the tool length adjustable. The powering device mount assembly 2100 comprises a mount assembly shaft 2120, and a powering device adjustment knob 2130. The mount assembly shaft 2120 is configured such that it can be extended and still be able to transfer power to the inner shaft 3100. By extending the mount assembly shaft 2120, the overall tool length can be extended. The powering device adjustment knob 2130 can be loosened first then the length can be adjusted, and then the powering device adjustment knob 2130 can be tightened again. Using this method, the operator can adjust the overall tool length as required. As someone skilled in the art will recognize, there are many alternative methods to make an adjustable tool length by adjusting the powering device mounting assembly.

### FIGS. 13A and B: Adjustable Powering Device Mounting Angle

The powering device mount assembly 2100 illustrated in FIGS. 13A and B allows for the adjustment of the angle the powering device is mounted relative to the tool end. The benefit of adjusting the mounting angle is so that an impact tool operator can configure the orientation of the tool end that best matches the particular task at hand. For example, the device operator may want to configure the handle of the powering device to be perpendicular to the tool end when the impacting device is chipping ice or scraping material off a floor. An alternative example is that the operator may want the handle of the powering device to be parallel to the tool end when the tool operator is trying to remove roofing tiles and wants the angle between the impacting device and the roof or floor surface to be as low as possible.

The powering device mounting assembly 2100 illustrated in FIGS. 13A and B shows one example way of making the powering device mounting angle adjustable. The powering device mounting assembly 2100 comprises a mount assembly shaft 2120, and a powering device adjust knob 2130. Using this configuration, it is possible to loosen the powering device adjustment knob 2130, then rotate the powering device to the desired angle, and then tighten the powering device adjustment knob. Using this apparatus and method, it is possible to adjust the angle of the powering device handle relative to the tool end.

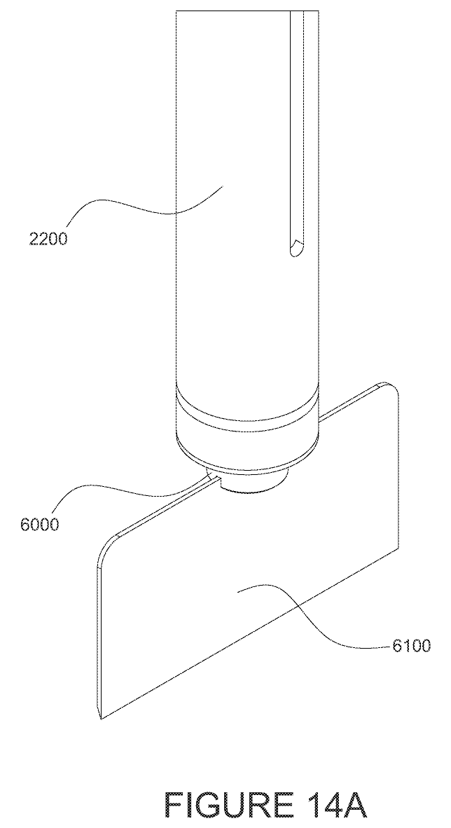

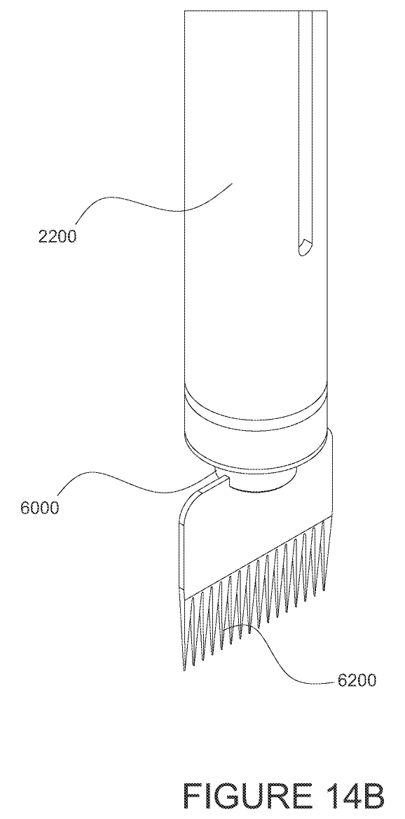

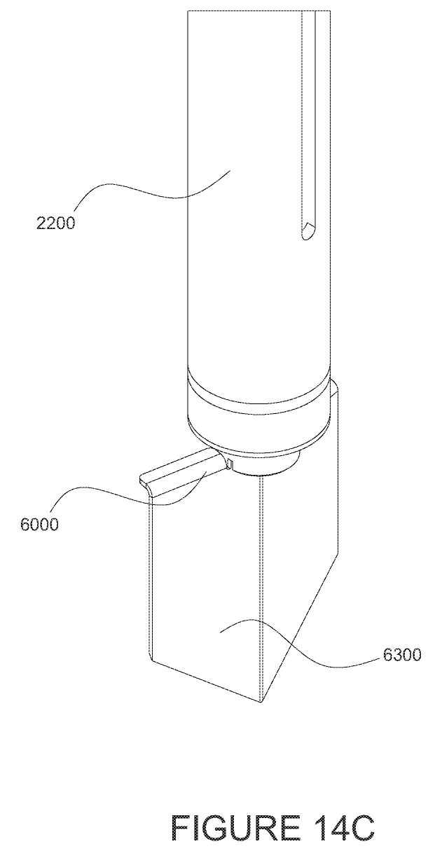

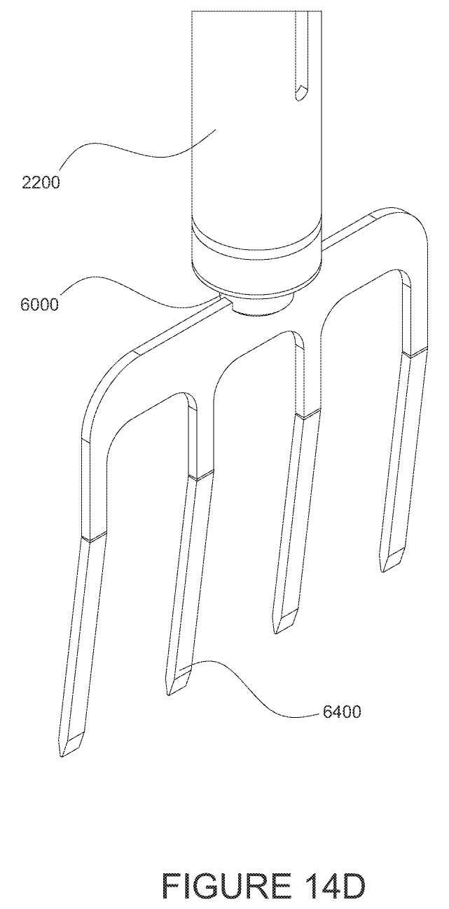

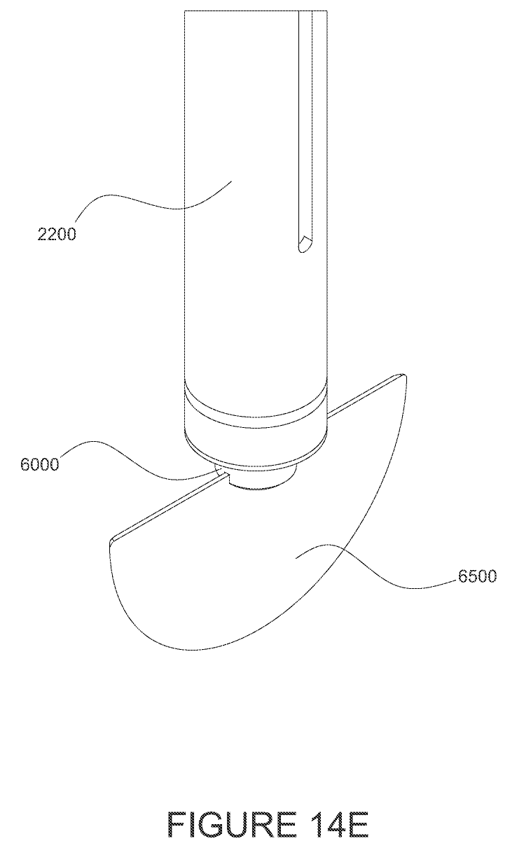

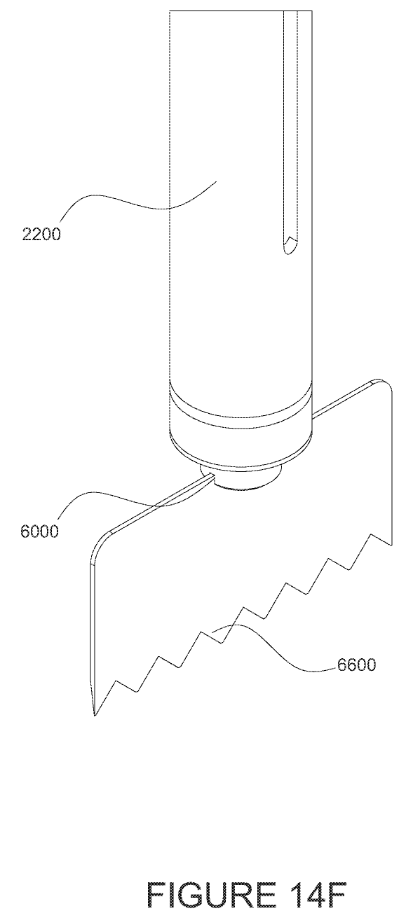

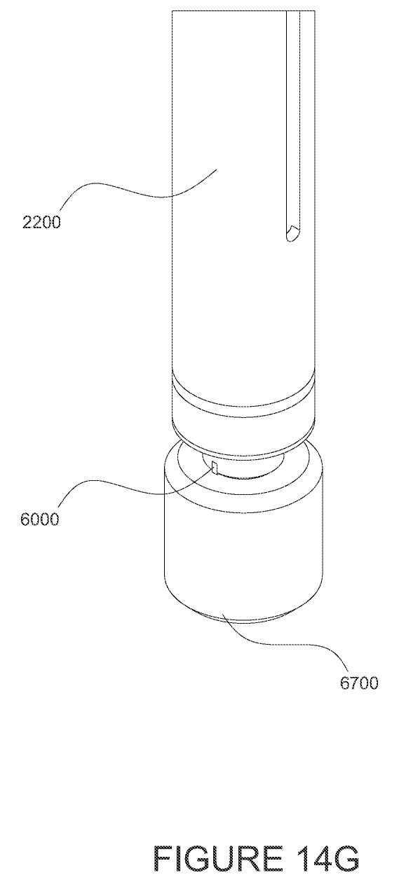

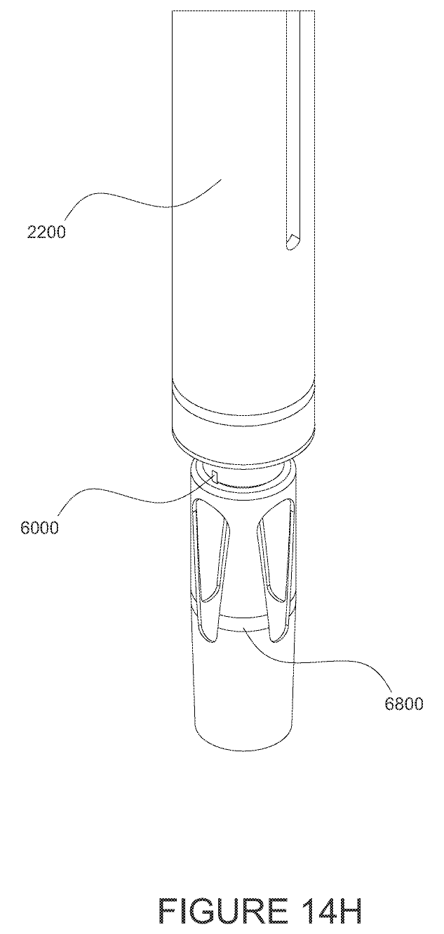

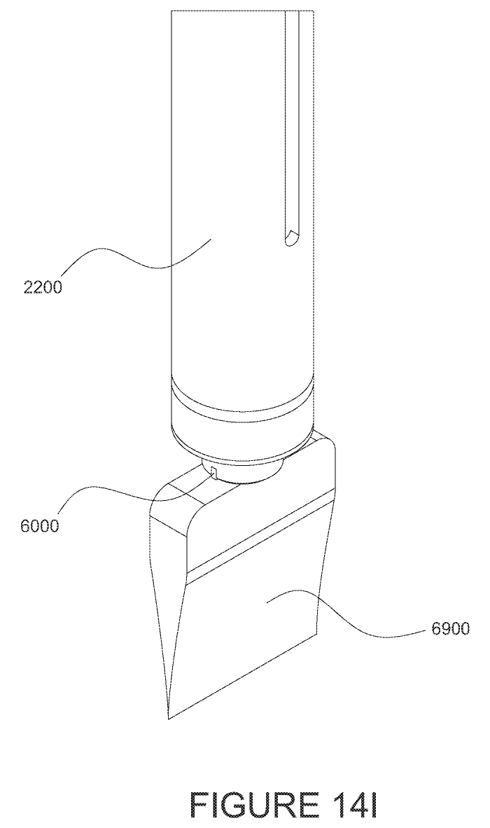

### FIGS. 14A-I: Example Tool Heads

FIGS. 14A-I illustrate several examples of tool heads for use with an impact tool, such as the impact tool illustrated in FIG. 9. This list of tool heads is illustrative of several common tool heads for common tasks.

For example, FIG. 14A illustrates an exemplary flat blade tool head for use with an impact tool, such as the impact tool illustrated in FIG. 9. This tool head can be used for multiple tasks including scraping and chipping. It is possible to have shorter flat blade tool heads that concentrate the impact energy in a smaller area, or have a larger flat tool heads that can scrape a larger area with a single pass.

FIG. 14B illustrates an exemplary pickle fork tool head 6200 for use with an impact tool, such as the impact tool illustrated in FIG. 9. This tool head can be useful for breaking targets that crack along lines of propagation. An example is chipping ice, rocks, or cement. This tool head is effective because it is able to concentrate impact energy in a several small regions along the line of crack propagation. Cracks from these small regions may tend for join together into longer lines of crack propagation.

FIG. 14C illustrates an exemplary shovel tool head 6300 for use with an impact tool, such as the impact tool illustrated in FIG. 9. This tool head can be useful for multiple tasks including shoveling hard soil or roots. One advantage of this tool is its ability to concentrate impact energy but also make it convenient to scoop up dirt and debris after it is removed.

FIG. 14D illustrates an exemplary pitchfork head 6400 for use with an impact tool, such as the impact tool illustrated in FIG. 9. This tool head can be useful for many tasks including prying loosely bound materials apart or concentrating energy in an impact zone between two surfaces such as flooring or roofing tiles.

FIG. 14E illustrates an exemplary lawn edger tool head 6500 for use with an impact tool, such as the impact tool illustrated in FIG. 9. This tool head can be useful for many tasks including edging lawns.

FIG. 14F illustrates an exemplary serrated edge tool head 6600 for use with an impact tool, such as the impact tool illustrated in FIG. 9. This tool head can be useful for many tasks including those that require cutting or chipping loosely bound targets.

FIG. 14G illustrates an exemplary hammer tool head 6700 for use with an impact tool, such as the impact tool illustrated in FIG. 9. This tool head can be useful for many tasks including those that require a hammering, pounding or tamping action.

FIG. 14H illustrates an exemplary hole digger tool head 6800 for use with an impact tool, such as the impact tool illustrated in FIG. 9. This tool head can be useful for many tasks including punching holes in soil for aeration, removing weeds, or for planting plants in soil.

FIG. 14I illustrates an exemplary axe tool head for use with an impact tool, such as the impact tool illustrated in FIG. 9. This tool head can be useful for many tasks including demolition work or cutting wood.

In one arrangement, an impact tool comprises a drive shaft, a spring configured to store and release energy, a tool head configured to deliver the energy stored in the spring onto a target, wherein rotation of the drive shaft causes energy to be stored in the spring, wherein when the spring stores sufficient energy for one strike, the energy is released, causing the energy to be transferred into a target, and wherein the device has a tool housing such that the maximum stroke length exceeds a minimum characteristic dimension of the tool housing, the impact tool further comprising a cam, a follower, and a linear guide wherein the linear guide prevents rotation of the striker.

In one arrangement, the impact tool comprises an anvil that is mechanically isolated from an impact tool housing.

In one arrangement, a length of the tool is adjustable.

In one arrangement, an anvil is operably coupled to a tool head, wherein the tool head allows tool effectors to be interchanged.

In one arrangement, the impact tool further comprising a noise dampening pad positioned between the striker and an anvil.

In one arrangement, a stroke length is adjustable by the tool operator.

In one arrangement, a housing is configured to provide a supporting structure for the motor.

In one arrangement, a handle is configured to be positioned along the midpoint of a tool body of the impact tool.

In one arrangement, An impact tool comprising: - a drive shaft; - at least one spring configured to store and release energy; - a tool head configured to deliver the energy stored in the spring onto a target - wherein rotation of the drive shaft causes energy to be stored in the spring - wherein when the spring stores sufficient energy for one strike, the energy is released, causing the energy to be transferred into a target, - wherein the stored impact energy per strike is adjustable by the operator

In one arrangement, a spring comprises an extension spring,

In one arrangement, a spring comprises an extension spring.

In one arrangement, a spring comprises an pneumatic spring or air spring.

In one arrangement, the stroke length is greater than 2 inches.

In one arrangement, the impact tool comprising an adjustable stop configured to change the stroke length.

In one arrangement, the impact tool comprises at least one cam,

In one arrangement, the impact tool comprises a barrel cam and a follower,

In one arrangement, the barrel cam has over rotation protection

In one arrangement, the barrel cam has a push to activate feature.

In one arrangement, the barrel cam has a reverse protection feature.

In one arrangement, the impact tool further comprising an anvil mechanically isolated from the housing.

In one arrangement, the tool further comprises a push to activate feature.

In one arrangement, the tool further discharges the spring energy when deactivated

In one arrangement, the energy in the spring is discharged automatically when the impact tool is deactivated.

In one arrangement, a length of the impact tool is adjustable.

In one arrangement, the impact tool has a viewing window.

In one arrangement, an anvil is operably coupled to a tool head, wherein the tool head allows tool effectors to be interchanged.

In one arrangement, the impact tool further comprising a noise dampening pad between the striker and an anvil.

In one arrangement, the impact tool further comprising a motor wherein when the motor is energized, the motor rotates the drive shaft.

In one arrangement, the striker is driven to engage an anvil.

In one arrangement, the striker is driven to engage a tool effector or tool head.

In one arrangement, the impact tool further comprising a handle that can be positioned along a midpoint of a tool body of the impact tool.

In one arrangement, an impact tool comprising a drive shaft,a spring configured to store and release energy;a tool head configured to deliver the energy stored in the spring onto a target,wherein rotation of the drive shaft causes energy to be stored in the spring,wherein when the spring stores sufficient energy for one strike, the energy is released, causing the energy to be transferred into a target,wherein the impact tool does not contain a motor but is configured as an attachment to a tool comprising a motor that can rotate the drive shaft, and wherein the impacting tool is configured to be a lawn trimmer or lawn edger.

In one arrangement, the attachment comprises a gear reduction

In one arrangement, an anvil is operably coupled to a tool head.

In one arrangement, a stroke length is adjustable by adjusting the position of a top trigger.

In one arrangement, the impact tool comprises an anvil that is mechanically isolated from a impact tool housing.

In one arrangement, the impact tool comprises a barrel cam and a follower,

In one arrangement, the impact tool comprises a push to activate feature.

In one arrangement, the energy in a spring is discharged automatically when the impact tool is deactivated.

In one arrangement, a length of the tool is adjustable by the operator.

In one arrangement, an anvil is operably coupled to a tool head, wherein the tool head allows tool effectors to be interchanged.

In one arrangement, the impact tool further comprising a noise dampening pad between the striker and an anvil.

In one arrangement, the impact tool further comprising a handle that can be positioned along a midpoint of an impact tool housing.

In one arrangement, the angle of the powering device relative to the tool head can be adjustable by an operator.

In one arrangement, an impact tool comprising a drive shaft, a spring configured to store and release energy; a tool end configured to deliver the energy stored in at least one spring onto a target, a cam and follower, a linear guide, wherein the spring is positioned around the drive shaft in a preloaded state, wherein rotation of the drive shaft causes energy to be stored in a spring, wherein when the springs store sufficient energy for one strike, the energy is released, causing a striker to move, and the energy is transferred into a target, wherein the cam is operably coupled to the drive shaft such that when the drive shaft rotates, the cam also rotates, wherein the linear guide prevents the striker from rotating, wherein the follower is operably coupled to the striker, such that when the cam rotates, the follower will move the striker in a way that causes energy to be stored in the spring.

In one arrangement, the impact tool comprising an anvil operably coupled to a tool holder, wherein the tool holder allows tool head or tool effectors to be interchanged.

In one arrangement, wherein the anvil defines a cavity configured to receive at least one bearing member that facilitates a rotation of the cam.

In one arrangement, wherein a stroke length comprises a length of 2 to 18 inches.

In one arrangement, a reciprocating mechanism comprising a barrel cam, a follower, at least one spring, a follower linkage wherein the spring is configured to store and release energy on each cycle of the mechanism, the barrel cam rotates more than one rotation for each cycle of the mechanism, the follower is removed and inserted into the barrel cam track by a follower linkage on each cycle of the mechanism, when the follower is inserted into the barrel cam track, energy may be stored in the springs, when the follower is removed from the barrel cam track, energy may be released from the springs

, In one arrangement, the center of mass and inertia the follower and follower linkage are configured so that the acceleration of the follower and follower linkage generates a force that assists in holding the follower out of the barrel cam track while the spring energy is being released.

In one arrangement, wherein a stroke length is adjustable by adjusting the position of the top trigger.

In one arrangement, wherein the cam comprises a barrel cam.

In one arrangement, wherein a stroke length is greater than 2 inches.

In one arrangement, the impact tool comprising an anvil mechanically isolated from an impact tool housing.

In one arrangement, the impact tool further comprising a push to activate feature.

In one arrangement, the energy in a spring is discharged automatically when the impact tool is deactivated.

In one arrangement, a length of the impact tool is adjustable by the operator.

In one arrangement, the impact tool further comprising a noise dampening pad located between the striker and an anvil.

the impact further comprising a handle that can be positioned along a midpoint of a tool body of the impact tool.

In one arrangement, the cam comprises a barrel cam that provides at least one rotation per impact.

The description of the different advantageous embodiments has been presented for purposes of illustration and description and is not intended to be exhaustive or limited to the embodiments in the form disclosed. Modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

Listing of Claims:

1. (Currently Amended) An impact tool configured to operate with a tool head, the impact tool comprising:
a drive shaft;
at least one spring configured to store and release energy;
a tool housing;
wherein the tool head, when attached, is operable to transfer the delivered energy into a target
wherein rotation of the drive shaft causes energy to be stored in the spring
wherein when the spring stores sufficient energy for one strike, the energy is released, causing the energy to be transferred into a target; and
wherein the impact tool is configured with a long stroke length, the long stroke length being defined as any stroke length that exceeds a minimum characteristic dimension of the tool housing or is greater than two inches.

2. (Original) The impact tool of claim 1 further comprises at least one cam and follower.

3. (Original) The impact tool of claim 1, wherein the impact tool comprises an anvil that is mechanically isolated from an impact tool housing.

4. (Original) The impact tool of claim 1, wherein the impact tool comprises a push to activate feature.

5. (Original) The impact tool of claim 1, wherein a spring is selected from the group consisting of a compression spring, extension spring, spiral spring, disc spring, leaf spring, and pneumatic spring.

6. (Original) The impact tool of claim 1, further comprising a motor and a gear reducer,
wherein the gear reducer is operably coupled between the motor and the drive shaft.

7. (Withdrawn) An impact tool comprising:
a drive shaft;
at least one spring configured to store and release energy;
a mechanism configured to deliver the energy stored in the spring into a target - wherein rotation of the drive shaft stores energy in the spring - wherein, when the spring accumulates sufficient energy for a strike, the energy is released and transferred into the target; and
wherein the impact energy per strike is operator adjustable.

8. (Withdrawn) (Withdrawn) The impact tool of claim 7, wherein the impact energy per strike is adjustable by adjusting a preloading of a spring.

9. The impact tool of claim 7, wherein the impact energy per strike is operator adjustable by adjusting the stroke length.

10. (Withdrawn) The impact tool of claim 7, wherein the stroke length is operator adjustable by adjusting the position of the top of the stroke.

11. (Withdrawn) The impact tool of claim 7, wherein the impact energy per strike is operator adjustable by adjusting the friction during the striker downstroke.

12. (Withdrawn) The impact tool of claim 7, wherein a spring is selected from the group consisting of a compression spring, extension spring, spiral spring, disc spring, leaf spring, and pneumatic spring.

13. (Withdrawn) The impact tool of claim 7, wherein a spring is positioned around the drive shaft.

14. (Withdrawn) The impact tool of claim 7, further comprising at least one cam and follower.

15. (Withdrawn) An impact tool configured to operate with a tool head, the impact tool comprising:
a drive shaft,
at least one spring configured to store and release energy;
wherein the tool head, when attached, is operable to transfer the delivered energy into a target,
wherein rotation of the drive shaft causes energy to be stored in the spring,
wherein when the spring stores sufficient energy for one strike, the energy is released, causing the energy to be transferred into a target; and
wherein the impact tool does not contain a motor but is configured as an attachment to a powering device that can rotate the drive shaft.

16. (Withdrawn) The impact tool of claim 15, wherein the impacting tool is configured for attachment to a powering device, such as a drill, a lawn trimmer, or another powering device.

17. (Withdrawn) The impact tool of claim 15, wherein the attachment comprises a gear reduction that, when coupled to the powering device, is operatively coupled to the impacting tool drive shaft, thereby reducing the drive shaft's rotational speed and increasing its torque.

18. (Withdrawn) The impact tool of claim 15 comprising at least one cam and follower.

19. (Withdrawn) The impact tool of claim 15 wherein the impact tool comprises a tool housing, and is configured with a "long stroke length," the long stroke length being defined as any stroke length that exceeds a minimum characteristic dimension of the tool housing or is greater than two inches.

20. (Withdrawn) The impact tool of claim 15 further comprising a feature to protect against damage caused by rotation in a wrong direction.

21. (Withdrawn) An impact tool configured to operate with a tool head, the impact tool comprising:
a drive shaft,
at least one spring configured to store and release energy,
a tool holder configured to attach a tool head or to incorporate a permanently attached tool head;
wherein the tool head, when attached, is operable to transfer the delivered energy into a target,
wherein rotation of the drive shaft causes energy to be stored in the spring,
wherein when a spring stores sufficient energy for one strike, the energy is released, causing the energy to be transferred into the target; and
wherein the impact tool is configured as a long reach design, such that the longest distance from an operator handle to the target is more than three times the distance from the target to the tool holder when a standard tool head touches the target.
